(19) United States
(12) Patent Application Publication
(10) Pub. No.: US 2026/0079461 A1
(43) Pub. Date: Mar. 19, 2026

(54) ARITHMETIC METHOD, ARITHMETIC DEVICE, AND PROGRAM

(71) Applicants: Kabushiki Kaisha Toshiba, Kawasaki-shi (JP); Toshiba Electronic Devices & Storage Corporation, Kawasaki-shi (JP)

(72) Inventors: Hitoshi IMI, Yokohama Kanagawa (JP); Motochika OKANO, Chuo Tokyo (JP)

(21) Appl. No.: 19/316,625

(22) Filed: Sep. 2, 2025

(30) Foreign Application Priority Data
Aug. 1, 2025 (JP) 2025-129301
Jul. 4, 2025 (JP) 2025-113646
Sep. 18, 2024 (JP) 2024-161027

(51) Int. Cl. G05B 17/02

(52) U.S. Cl. CPC G05B 17/02

(57) ABSTRACT

In an arithmetic method according to an embodiment, executing an arithmetic operation includes performing first simulation when a control target is driven in a first drive pattern using a simulation model in which an element model is a model in which electrical characteristics of a switching element are resistance characteristics, extracting first time-series data of a drive signal output from a control model in the first simulation, and performing second simulation when the control target is driven in the first drive pattern using the simulation model in which the control model is a model from which the first time-series data is output along a time series and in which the element model is a model in which power loss including switching loss that occurs when a state of the switching element is switched can be output.

### CROSS-REFERENCE TO RELATED APPLICATION

This application is based upon and claims the benefit of priority from Japanese Patent Application No. 2024-161027, filed September 18, 2024, Japanese Patent Application No. 2025-113646, filed July 4, 2025, and Japanese Patent Application No. 2025-129301, filed August 1, 2025; the entire contents of which are incorporated herein by reference.

### FIELD

Embodiments of the present invention relate to an arithmetic method, an arithmetic device, and a program.

### BACKGROUND

In a circuit including a switching element, it is necessary to verify a temperature of the switching element when the circuit is operated in advance according to simulation. In the simulation, when a model of the circuit including the switching element is set to a detailed model, the temperature of the switching element when the circuit is operated can be calculated more accurately. However, there is a problem that the time required for simulation increases when the model of the circuit is set to a detailed model.

### BRIEF DESCRIPTION OF THE DRAWINGS

FIG. 1 is a block diagram showing a configuration of an arithmetic device in a first embodiment.

FIG. 2 is a diagram showing an example of a motor system serving as a simulation target in the first embodiment.

FIG. 3 is a diagram showing an example of a simulation model in the first embodiment.

FIG. 4 is a diagram showing another example of the simulation model in the first embodiment.

FIG. 5 is a diagram showing an example of a detailed element model in the first embodiment.

FIG. 6 is a diagram showing an example of a simplified element model in the first embodiment.

FIG. 7 is a graph showing an example of a drive signal output from a control model in the first embodiment.

FIG. 8 is a flowchart showing an example of a process executed by an arithmetic circuitry in the first embodiment.

FIG. 9 is a graph showing an example of a first drive pattern in the first embodiment.

FIG. 10 is a diagram showing an example of a switching operation of the simplified element model in pre-simulation of the first embodiment.

FIG. 11 is a diagram showing an example of a switching operation of the detailed element model in main simulation of the first embodiment.

FIG. 12 is a graph showing an example of a change in a temperature of the element model calculated in the main simulation of the first embodiment.

FIG. 13 is a graph showing an example of a noise level of electromagnetic interference noise calculated in the main simulation in the first embodiment.

FIG. 14 is a diagram showing an example of a motor system serving as a simulation target in a second embodiment.

FIG. 15 is a diagram showing an example of a simulation model in the second embodiment.

FIG. 16 is a diagram showing another example of the simulation model in the second embodiment.

FIG. 17 is a diagram showing yet another example of the simulation model in the second embodiment.

FIG. 18A is a flowchart showing a part of an example of a process executed by an arithmetic circuitry in the second embodiment.

FIG. 18B is a flowchart showing another part of the example of the process executed by the arithmetic circuitry in the second embodiment.

FIG. 18C is a flowchart showing yet another part of the example of the process executed by the arithmetic circuitry in the second embodiment.

FIG. 19 is a graph showing an example of a first drive pattern and an example of a second drive pattern in the second embodiment.

FIG. 20 is a diagram showing an example of a heat table in the second embodiment.

FIG. 21 is a diagram showing an example of a noise table in the second embodiment.

### DETAILED DESCRIPTION

An arithmetic method according to an embodiment is an arithmetic method of a computer. The arithmetic method according to the embodiment includes executing an arithmetic operation including simulation using a simulation model having an element model corresponding to a switching element and a control model corresponding to a controller that controls a control target by driving the switching element. Executing the arithmetic operation includes performing first simulation when the control target is driven in a first drive pattern using the simulation model in which the element model is a model in which electrical characteristics of the switching element are resistance characteristics, extracting first time-series data of a drive signal output from the control model in the first simulation, and performing second simulation when the control target is driven in the first drive pattern using the simulation model in which the control model is a model from which the first time-series data is output along a time series and in which the element model is a model in which power loss including switching loss that occurs when a state of the switching element is switched can be output.

Hereinafter, an arithmetic method, an arithmetic device, and a program of embodiments will be described with reference to the drawings.

### First Embodiment

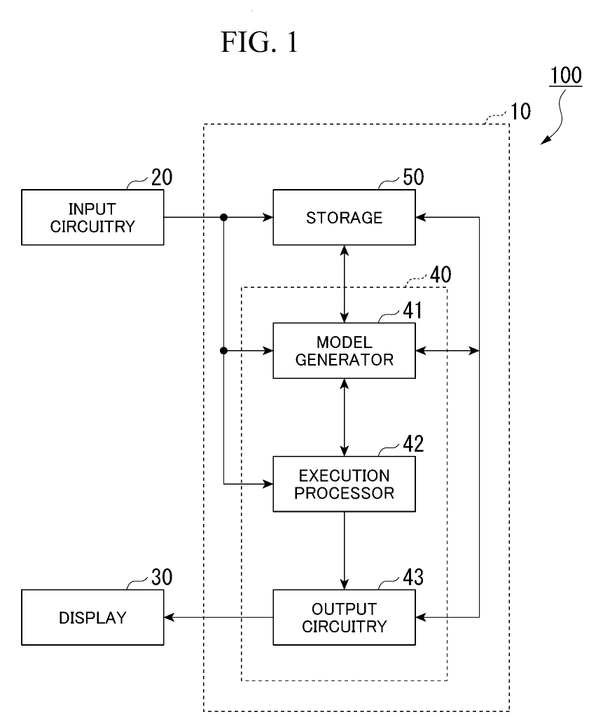

FIG. 1 is a block diagram showing a configuration of an arithmetic device 100 in a first embodiment. The arithmetic device 100 shown in FIG. 1 is a computer capable of performing various types of arithmetic operations. The arithmetic device 100 is a circuit simulator device capable of simulating a circuit. As shown in FIG. 1, the arithmetic device 100 includes an arithmetic device body 10, an input circuitry 20, and a display 30. The arithmetic device body 10 is a computer body. The input circuitry 20 is a portion that allows a user of the arithmetic device 100 to input various types of information to the arithmetic device body 10. The input circuitry 20 includes, for example, a keyboard, a pointing device connected to the arithmetic device body 10, and the like. The display 30 is a portion that displays an output from the arithmetic device body 10. The display 30 is, for example, a display connected to the arithmetic device body 10.

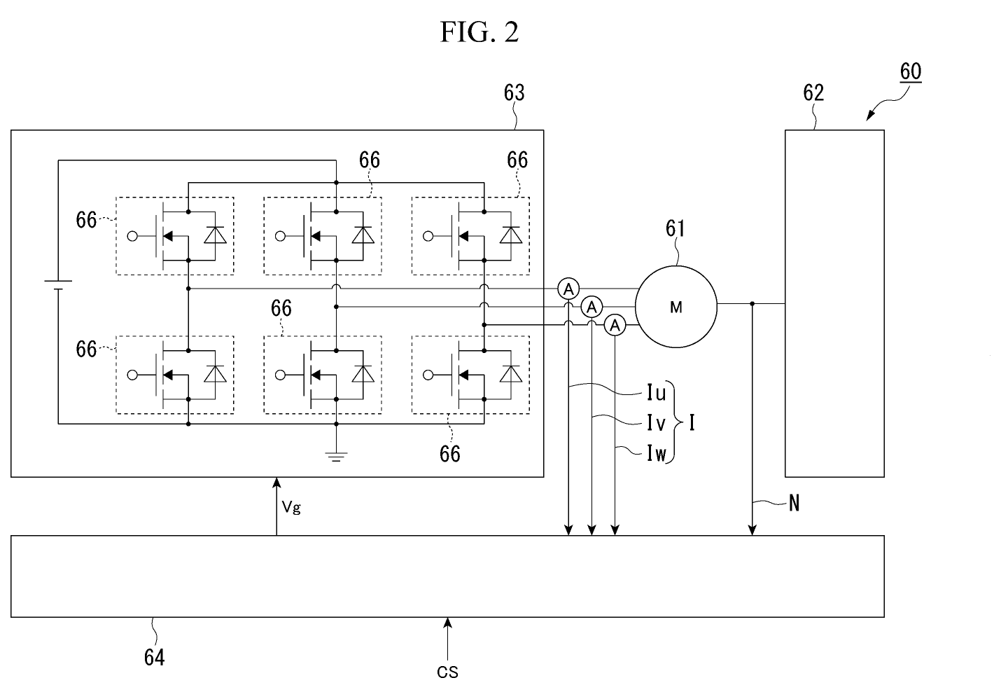

The arithmetic device body 10 includes an arithmetic circuitry 40 and a storage 50. The arithmetic circuitry 40 is a portion that executes various types of arithmetic operations. The arithmetic circuitry 40 is, for example, a microprocessor such as a CPU. The arithmetic circuitry 40 executes, for example, a program stored in the storage 50 and executes various types of operations. The arithmetic circuitry 40 executes an arithmetic operation including simulation using a simulation model 70 corresponding to the motor system 60 shown in FIG. 2. In other words, the arithmetic method of the arithmetic circuitry 40 includes executing an arithmetic operation including simulation using the simulation model 70.

FIG. 2 is a diagram showing an example of the motor system 60 serving as a simulation target. As shown in FIG. 2, the motor system 60 includes a motor 61, a driven device 62, an inverter circuit 63, and a controller 64. The motor 61 is, for example, a motor to which a three-phase alternating current is supplied from the inverter circuit 63. In the first embodiment, the motor 61 is a control target to be controlled by the controller 64. The driven device 62 is driven by the motor 61. The driven device 62 may be any device as long as at least a portion of the driven device 62 is driven by the motor 61. The driven device 62 is, for example, a pump mechanism portion of an electric pump, an electric power steering device, or the like. The inverter circuit 63 has a plurality of switching elements 66. The plurality of switching elements 66 are transistors. The plurality of switching elements 66 are, for example, metal-oxide-semiconductor field-effect transistors (MOSFETs). The plurality of switching elements 66 are, for example, N-channel type MOSFETs. The plurality of switching elements 66 may be P-channel type MOSFETs. In FIG. 2, among circuit symbols representing each of the switching elements 66, a symbol representing a diode represents a built-in diode of each of the switching elements 66 being transistors, that is, a body diode. The switching elements 66 may be transistors other than the MOSFETs. The switching elements 66 may be, for example, field-effect transistors (FETs) other than the MOSFETs. Alternatively, the switching elements 66 may be, for example, bipolar transistors such as insulated-gate bipolar transistors (IGBTs). The inverter circuit 63 has six switching elements 66. The six switching elements 66 include two switching elements 66 constituting a U-phase leg, two switching elements 66 constituting a V-phase leg, and two switching elements 66 constituting a W-phase leg.

The controller 64 controls the motor 61 by driving the plurality of switching elements 66. A command signal CS is input to the controller 64 from a host device (not shown). The controller 64 switches a state of each switching element 66 between an ON state and an OFF state by inputting a gate voltage Vg to each of the plurality of switching elements 66 on the basis of the command signal CS. In addition, the command signal CS may be a signal input from the driven device 62 to the controller 64. In this case, for example, when the driven device 62 is an electric power steering device and the motor 61 is a motor that performs a torque assist process necessary for manipulating a handle, the command signal CS input from the driven device 62 to the controller 64 is a torque command value required in accordance with the manipulation of the handle.

A motor-specific current I flowing through the motor 61 is fed back to the controller 64. In the first embodiment, the motor-specific current I includes a U-phase current Iu, a V-phase current Iv, and a W-phase current Iw. Each of the U-phase current Iu, the V-phase current Iv, and the W-phase current Iw is detected, for example, by an ammeter provided on wiring through which the current of each phase flows. The U-phase current Iu, the V-phase current Iv, and the W-phase current Iw may be detected in any way. A motor rotation speed N is fed back to the controller 64 as an output of the motor 61.

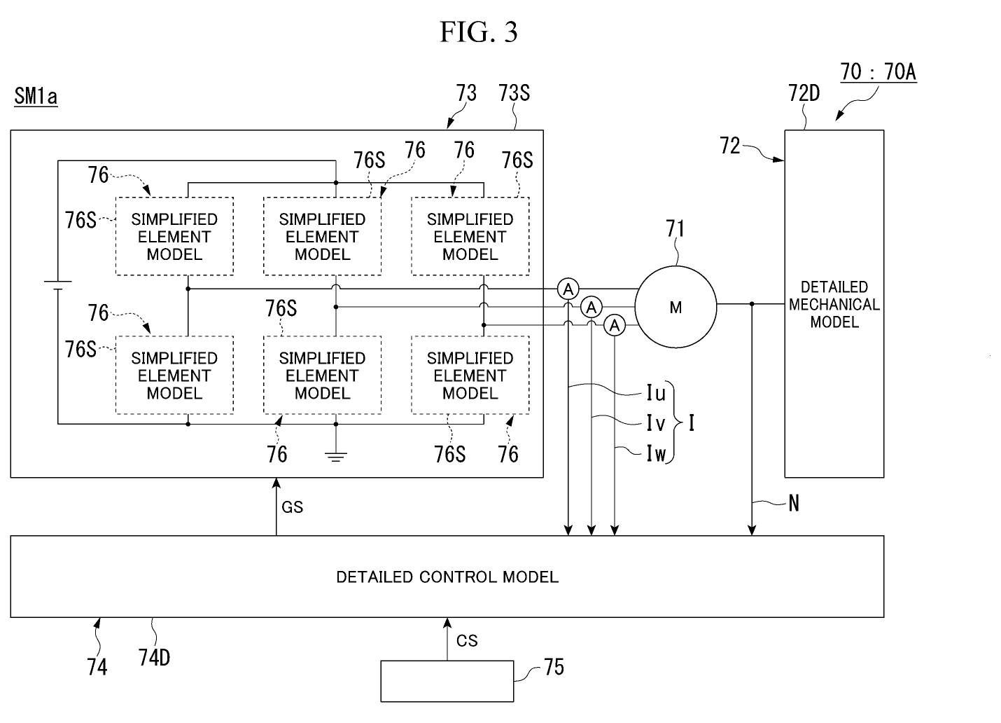

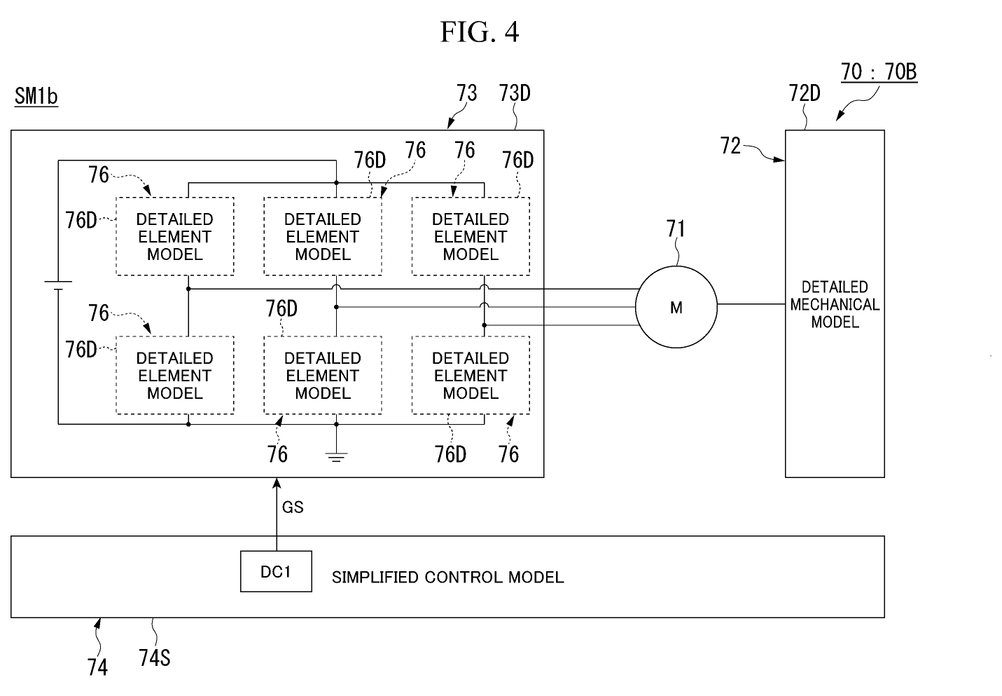

As shown in FIG. 1, the arithmetic circuitry 40 includes a model generator 41 that generates a simulation model 70. The model generator 41 generates the simulation model 70 by combining models corresponding to parts of the motor system 60. FIG. 3 is a diagram showing an example of the simulation model 70 in the first embodiment. FIG. 4 is a diagram showing another example of the simulation model 70 in the first embodiment. As shown in FIGS. 3 and 4, the simulation model 70 includes a motor model 71, a mechanical model 72, an inverter circuit model 73, and a control model 74.

The motor model 71 is a model corresponding to the motor 61 to which the motor-specific current I is supplied from the inverter circuit 63. The motor model 71 is, for example, a model corresponding to the motor 61 to which a three-phase alternating current is supplied from the inverter circuit 63. The mechanical model 72 is a model corresponding to the driven device 62 driven by the motor 61. The inverter circuit model 73 is a model corresponding to the inverter circuit 63 having the plurality of switching elements 66. The inverter circuit model 73 has a plurality of element models 76. The plurality of element models 76 are models corresponding to the plurality of switching elements 66. The plurality of element models 76 are models corresponding to the transistors. The plurality of element models 76 are, for example, models corresponding to MOSFETs. The inverter circuit model 73 in the first embodiment has six element models 76. The six element models 76 include two element models 76 corresponding to two switching elements 66 constituting the U-phase leg, two element models 76 corresponding to the two switching elements 66 constituting the V-phase leg, and two element models 76 corresponding to the two switching elements 66 constituting the W-phase leg. The control model 74 is a model corresponding to the controller 64 that controls the motor 61 that is a control target.

In the first embodiment, the model generator 41 generates two simulation models 70, i.e., a first simulation model 70A shown in FIG. 3 and a second simulation model 70B shown in FIG. 4. As shown in FIG. 3, in the first simulation model 70A, the element model 76 is a simplified element model 76S and the inverter circuit model 73 is a simplified inverter circuit model 73S. In the first simulation model 70A, the control model 74 is a detailed control model 74D. The first simulation model 70A includes a command value input circuitry 75 that inputs the command signal CS to the detailed control model 74D. As shown in FIG. 4, in the second simulation model 70B, the element model 76 is a detailed element model 76D and the inverter circuit model 73 is a detailed inverter circuit model 73D. In the second simulation model 70B, the control model 74 is a simplified control model 74S. Unlike the first simulation model 70A, the second simulation model 70B does not have the command value input circuitry 75.

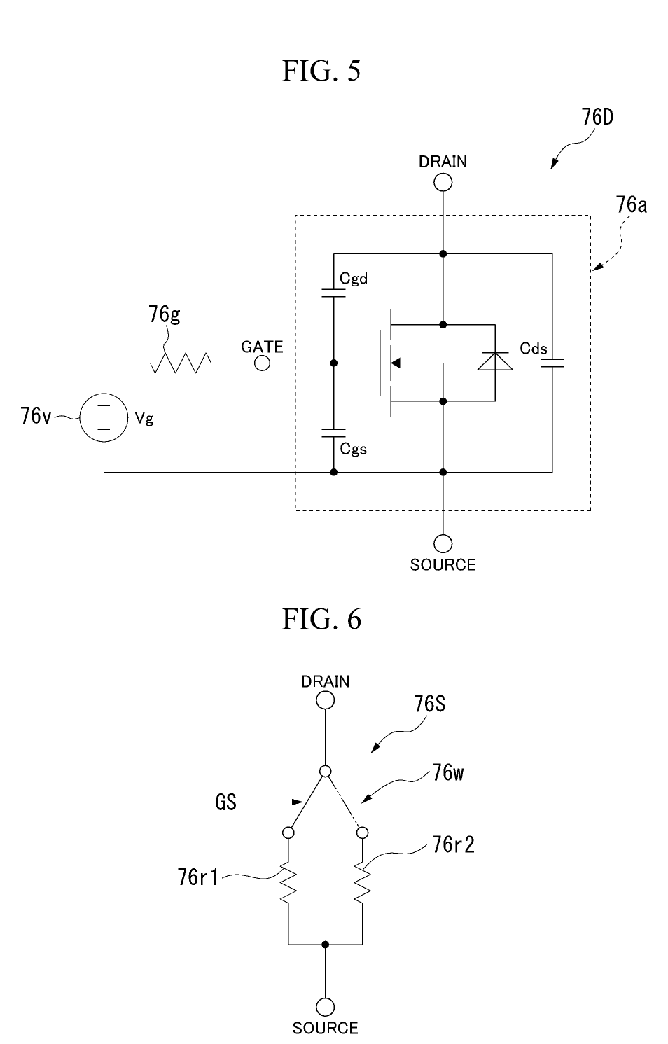

FIG. 5 is a diagram showing an example of the detailed element model 76D. The detailed element model 76D shown in FIG. 5 is a model capable of reproducing electrical characteristics in a transient response when the state of the switching element 66 is switched. In the first embodiment, the detailed element model 76D is a model capable of reproducing an operation including a transient response during switching of the MOSFET. The detailed element model 76D is a model in which information for calculating the transient response of the MOSFET such as capacitances Cgs and Cgd of an oxide film of the switching element 66, junction capacitance Cds of the built-in diode of each of the switching elements 66, that is, the body diode, switching time information, and a threshold voltage VGS as the electrical characteristics is specified. The detailed element model 76D is a model capable of outputting power loss including switching loss that occurs when the state of the switching element 66 is switched.

As shown in FIG. 5, the detailed element model 76D includes an element body model 76a, a gate resistor model 76g, and a voltage source model 76v. The element body model 76a is a model in which information for calculating the transient response of the MOSFET is specified. In FIG. 5, among circuit symbols representing the element body model 76a, a symbol representing a diode represents the built-in diode of the MOSFET, that is, the body diode. For example, the element body model 76a is a simulation program with integrated circuit emphasis (SPICE) model in which various types of parameters are provided. The gate resistor model 76g is a model corresponding to a gate resistor connected to a gate of the switching element 66. The voltage source model 76V is a model corresponding to a voltage source that applies a gate voltage between the gate and the source of the switching element 66. The voltage source model 76v converts the drive signal GS input from the control model 74 into a voltage and applies the voltage as the gate voltage Vg between the gate and the source of the element body model 76a.

FIG. 6 is a diagram showing an example of the simplified element model 76S. The simplified element model 76S is expressed as a simplified switch model capable of reproducing the switching between the ON state and the OFF state of the switching element 66. The simplified element model 76S is a model in which the transient response when the switching element 66 is switched between the ON state and the OFF state is not calculated. The simplified element model 76S is a model in which the electrical characteristics of the switching element 66 are resistance characteristics. The “model in which the electrical characteristics of the switching element 66 are resistance characteristics” is, for example, a model in which information necessary for calculating the transient response of the switching element 66 is not specified and the electrical characteristics of the switching element 66 are specified as the resistance characteristics of the switching element 66 in which a resistance value changes between the ON state and the OFF state.

As shown in FIG. 6, the simplified element model 76S includes a first resistor 76r1, a second resistor 76r2, and a switch 76w. The first resistor 76r1 and the second resistor 76r2 are arranged between a drain and a source. The switch 76w can switch the state of the simplified element model 76S between a state in which the drain and the source are connected via the first resistor 76r1 and a state in which the drain and the source are connected via the second resistor 76r2. The state of the switch 76w is switched in accordance with the drive signal GS input from the control model 74. A resistance value of the first resistor 76r1 is a resistance value of the switching element 66 in the case of the ON state. A resistance value of the second resistor 76r2 is a resistance value of the switching element 66 in the case of the OFF state. Therefore, when the state of the switch 76w is switched on the basis of the drive signal GS, the state of the simplified element model 76S is switched and an operation of changing the resistance value of the simplified element model 76S can be reproduced. The resistance value of the second resistor 76r2 is larger than the resistance value of the first resistor 76r1. In the example of FIG. 6, a state in which the switch 76w connects the drain and the first resistor 76r1 is indicated by a solid line and a state in which the switch 76w connects the drain and the second resistor 76r2 is indicated by a two-dot chain line.

The detailed control model 74D is a model in which the motor model 71 and the inverter circuit model 73 can be controlled as in the case where the controller 64 controls the motor 61 and the inverter circuit 63. As shown in FIG. 3, in the first embodiment, the detailed control model 74D controls the motor model 71 and the inverter circuit model 73 on the basis of the command signal CS from the command value input circuitry 75. The motor-specific current I and the motor rotation speed N are input to the detailed control model 74D. The detailed control model 74D controls the motor model 71 and the inverter circuit model 73 according to feedback control in which the motor-specific current I and the motor rotation speed N are fed back. In the first embodiment, the detailed control model 74D controls the motor model 71 and the inverter circuit model 73 according to pulse width modulation (PWM) control. The detailed control model 74D inputs a drive signal GS for switching the state of the element model 76 between the ON state and the OFF state to the inverter circuit model 73 on the basis of the command signal CS and the motor-specific current I and the motor rotation speed N that have been fed back. The detailed control model 74D generates a plurality of drive signals GS input to the plurality of element models 76 and inputs the plurality of drive signals GS to the plurality of element models 76.

The simplified control model 74S is a model from which a first time-series data DC1 of the drive signal GS obtained by pre-simulation SM1a to be described below using the detailed control model 74D is output along a time series as the drive signal GS output to the inverter circuit model 73 regardless of an input from another model or the like. The command signal CS, the motor-specific current I, and the motor rotation speed N are not input to the simplified control model 74S.

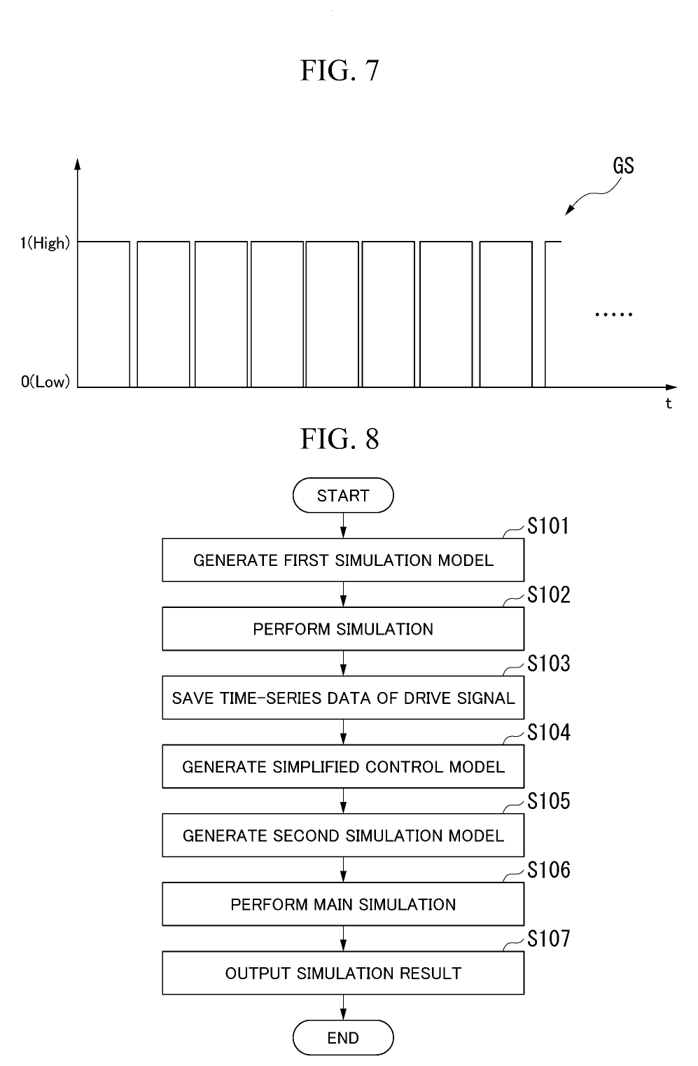

FIG. 7 is a graph showing an example of the drive signal GS output from the control model 74. In the graph of FIG. 7, the vertical axis represents a signal level and the horizontal axis represents time t. The drive signal GS is, for example, a square wave that can be switched between 1 (high) and 0 (low). When the drive signal GS input to the element model 76 is 1, the element model 76 is in the ON state. When the drive signal GS input to the element model 76 is 0, the element model 76 is in the OFF state. When the element model 76 is the detailed element model 76D and when the drive signal GS is 1, the voltage source model 76v sets a voltage value applied between a gate and a source of the detailed element model 76D to a predetermined voltage value greater than or equal to a threshold voltage. When the element model 76 is the detailed element model 76D and the drive signal GS is 0, the voltage source model 76v sets the voltage value applied between the gate and the source of the detailed element model 76D to a predetermined voltage value less than the threshold voltage. When the element model 76 is the simplified element model 76S and the drive signal GS is 1, the switch 76w is in a state in which the drain and the first resistor 76r1 are connected. When the element model 76 is the simplified element model 76S and the drive signal GS is 0, the switch 76w is in a state in which the drain and the second resistor 76r2 are connected.

As shown in FIGS. 3 and 4, in the first simulation model 70A and the second simulation model 70B, both mechanical models 72 are detailed mechanical models 72D. The detailed mechanical model 72D is a model made by modeling each part constituting the driven device 62 and is a model capable of calculating the load applied by the driven device 62 to the motor 61 in accordance with an input from the motor 61. The detailed mechanical model 72D adds the calculated load to the motor model 71.

As shown in FIG. 1, the arithmetic circuitry 40 includes an execution processor 42 and an output circuitry 43. The execution processor 42 is a portion that executes simulation using the simulation model 70 generated in the model generator 41. In the first embodiment, the execution processor 42 can execute the pre-simulation SM1a using the first simulation model 70A and main simulation SM1b using the second simulation model 70B. In the first embodiment, the pre-simulation SM1a corresponds to “first simulation.” In the first embodiment, the main simulation SM1b corresponds to “second simulation.”

The output circuitry 43 is a portion that outputs a processing result of the execution processor 42. The output circuitry 43 outputs the processing result of the execution processor 42 to the storage unit 50. The output circuitry 43 outputs, for example, the processing result of the execution processor 42 to the storage unit 50 for each time step. The output circuitry 43 generates a display image on the basis of the processing result of the execution processor 42. The output circuitry 43 outputs the display image to the display 30.

FIG. 8 is a flowchart showing an example of a process executed by the arithmetic circuitry 40 in the first embodiment. The flow of the process shown in FIG. 8 is a flow in which simulation for the case where the motor 61 in the motor system 60 is driven in a certain drive pattern is executed and a process of estimating a change in a temperature of the switching element 66 and a noise level of electromagnetic interference noise (EMI noise) occurring in the motor system 60 caused by the switching element 66 is performed by the simulation.

As shown in FIG. 8, the arithmetic circuitry 40 generates a first simulation model 70A (step S101). In the first embodiment, the arithmetic circuitry 40 generates the first simulation model 70A with the model generator 41. The model generator 41 may generate the first simulation model 70A by selecting a model of each part of the motor system 60 or may generate the first simulation model 70A by replacing the element model 76 in the detailed simulation model 70 corresponding to the motor system 60 with the simplified element model 76S.

The arithmetic circuitry 40 performs the pre-simulation SM1a using the first simulation model 70A (step S102). In the first embodiment, the arithmetic circuitry 40 performs the pre-simulation SM1a with the execution processor 42. The pre-simulation SM1a is simulation in which the controller 64 drives the motor 61 in a first drive pattern DP1. That is, in the arithmetic method of the first embodiment, executing the arithmetic operation includes performing the pre-simulation SM1a when the motor 61 is driven in the first drive pattern DP1 using the first simulation model 70A in which the element model 76 is the simplified element model 76S. The time step width in the pre-simulation SM1a is larger than the time step width in the main simulation SM1b. The time step width in the pre-simulation SM1a is a coarse time step width within a range in which the control operation using the first simulation model 70A can be reproduced. The time step width in the pre-simulation SM1a is, for example, about 5 times or more and 30 times or less the time step width in the main simulation SM1b.

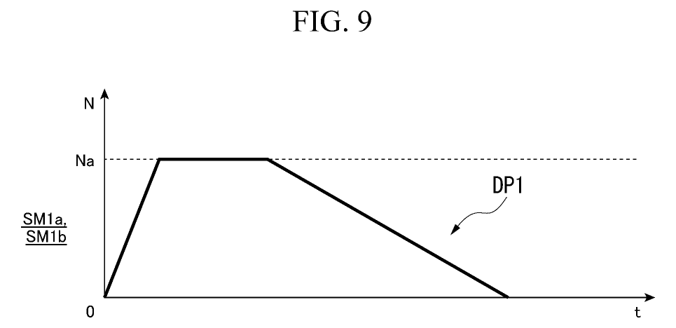

FIG. 9 is a graph showing an example of the first drive pattern DP1. In the graph of FIG. 9, the vertical axis represents the motor rotation speed N and the horizontal axis represents time t. In the example of FIG. 9, the first drive pattern DP1 is a drive pattern in which the motor 61 is driven so that the motor rotation speed N is maintained constant for a certain period of time after rising linearly from zero to a rotation speed Na, and then linearly decreases to zero again.

As shown in FIG. 3, in the pre-simulation SM1a, the inverter circuit model 73 is the simplified inverter circuit model 73S, the element model 76 is the simplified element model 76S, and the control model 74 is the detailed control model 74D. In the pre-simulation SM1a, the command signal CS necessary for driving the motor 61 in the first drive pattern DP1 is input from the command value input circuitry 75 to the detailed control model 74D. In the pre-simulation SM1a, the motor-specific current I and the motor rotation speed N are fed back to the detailed control model 74D.

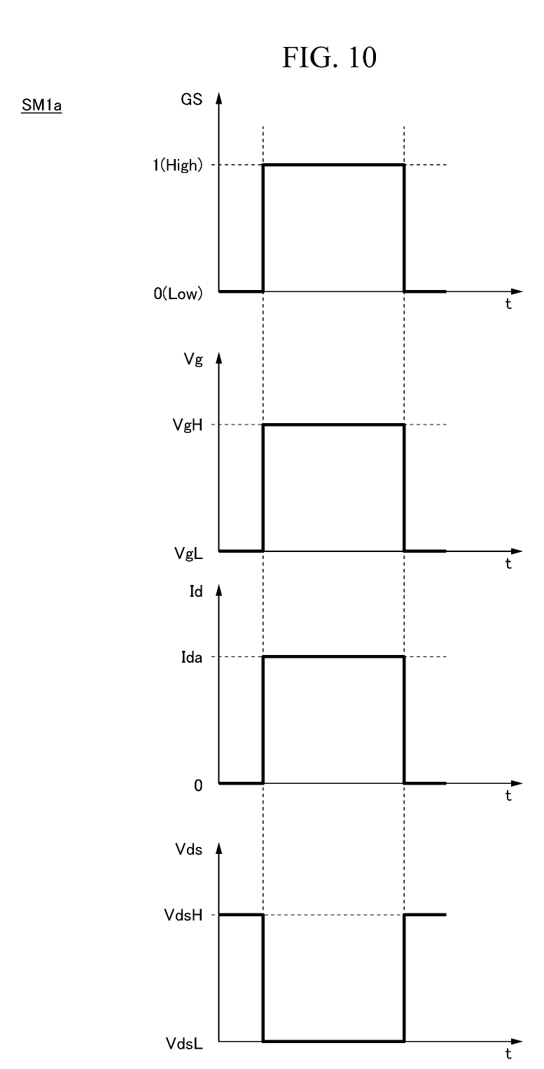

In the pre-simulation SM1a, the detailed control model 74D generates the drive signal GS as shown in FIG. 7 for each of the plurality of simplified element models 76S on the basis of the input command signal CS and inputs the drive signal GS to each simplified element model 76S. The state of each simplified element model 76S is switched between the ON state and the OFF state on the basis of the input drive signal GS. FIG. 10 is a diagram showing an example of a switching operation of the simplified element model 76S in the pre-simulation SM1a. A graph at the top of FIG. 10 shows a change in the drive signal GS. A second graph from the top of FIG. 10 shows a change in the gate voltage Vg of the simplified element model 76S. A third graph from the top of FIG. 10 shows a change in a drain current Id flowing through the simplified element model 76S. A graph at the bottom of FIG. 10 shows a change in a drain-source voltage Vds of the simplified element model 76S. In each graph of FIG. 10, the horizontal axis represents time t. The simplified element model 76S is, for example, a model in which the gate voltage Vg, the drain current Id, and the drain-source voltage Vds change as shown in FIG. 10 on the basis of the input drive signal GS.

As shown in FIG. 10, in the pre-simulation SM1a, at the moment when the drive signal GS changes from 0 (low) to 1 (high), the gate voltage Vg changes from a voltage VgL to a voltage VgH higher than the threshold voltage. The voltage VgL is a voltage lower than the threshold voltage, for example, 0 [V]. The voltage VgL may be any value as long as it is lower than the threshold voltage. The gate voltage Vg is maintained constant at the voltage VgH while the drive signal GS is 1. In the pre-simulation SM1a, at the moment when the drive signal GS changes from 0 to 1, the state of the switch 76w of the simplified element model 76S is switched from a state in which the drain and the source are connected via the second resistor 76r2 to a state in which the drain and the source are connected via the first resistor 76r1. Thereby, the operation in which the state of the simplified element model 76S is switched from the OFF state to the ON state is reproduced. In the pre-simulation SM1a, at the moment when the simplified element model 76S is in the ON state, a resistance value between the drain and the source of the simplified element model 76S becomes the resistance value of the first resistor 76r1 and the drain current Id flows at a value Ida. Moreover, in the pre-simulation SM1a, at the moment when the simplified element model 76S is in the ON state, the drain-source voltage Vds changes from a voltage VdsH to the voltage VdsL lower than the voltage VdsH. While the drive signal GS is 1, the drain current Id flows constantly at the value Ida and the drain-source voltage Vds is maintained constant at the voltage VdsL.

In the pre-simulation SM1a, the gate voltage Vg changes from the voltage VgH to the voltage VgL at the moment when the drive signal GS changes from 1 (high) to 0 (low). The gate voltage Vg is maintained constant at the voltage VgL while the drive signal GS is 0. In the pre-simulation SM1a, at the moment when the drive signal GS changes from 1 to 0, the state of the switch 76w of the simplified element model 76S is switched from a state in which the drain and the source are connected via the first resistor 76r1 to a state in which the drain and the source are connected via the second resistor 76r2. Thereby, an operation in which the state of the simplified element model 76S changes from the ON state to the OFF state is reproduced. In the pre-simulation SM1a, at the moment when the simplified element model 76S is in the OFF state, the resistance value between the drain and the source of the simplified element model 76S becomes the resistance value of the second resistor 76r2 and the drain current Id does not flow. Moreover, in the pre-simulation SM1a, the drain-source voltage Vds changes from the voltage VdsL to the voltage VdsH at the moment when the simplified element model 76S is in the OFF state. While the drive signal GS is 0, the drain current Id does not flow and the drain-source voltage Vds is maintained constant at the voltage VdsH.

As shown in FIG. 8, the arithmetic circuitry 40 saves time-series data of the drive signal GS output from the detailed control model 74D in the pre-simulation SM1a (step S103). In step S103, the arithmetic circuitry 40, for example, saves time-series data of the drive signal GS output from the detailed control model 74D via the output circuitry 43 in the storage 50. The time-series data of the drive signal GS output from the detailed control model 74D is the first time-series data DC1. The first time-series data DC1 includes the time-series data of the drive signal GS input to each of a plurality of simplified element models 76S in the pre-simulation SM1a. In step S103, the arithmetic circuitry 40 may save the first time-series data DC1 in the storage 50 after the pre-simulation SM1a is completed or may save the first time-series data DC1 in the storage 50 by saving the data of the drive signal GS in the storage 50 sequentially during the execution of the pre-simulation SM1a. Thus, executing the arithmetic operation in the arithmetic method of the first embodiment includes extracting the first time-series data DC1 of the drive signal GS output from the control model 74 in the pre-simulation SM1a.

Here, in the pre-simulation SM1a, the drive signal GS output from the detailed control model 74D is decided on the basis of the command signal CS and the motor-specific current I and the motor rotation speed N that have been fed back. A magnitude of the motor-specific current I is unaffected or substantially unaffected by the change in the drain current Id in the transient response when the state of the switching element 66 is switched. Therefore, even as the simplified element model 76S in which the element model 76 cannot reproduce the electrical characteristics of the transient response during switching in the pre-simulation SM1a, the motor-specific current I output from the inverter circuit model 73 is the same as or substantially the same as when the element model 76 is the detailed element model 76D capable of reproducing the electrical characteristics of the transient response during switching. The motor rotation speed N is determined by the motor-specific current I input to the motor model 71 and the load received from the mechanical model 72 connected to the motor model 71. In the pre-simulation SM1a, the mechanical model 72 is the detailed mechanical model 72D. Therefore, in the pre-simulation SM1a, the load received by the motor model 71 from the mechanical model 72 is the same as the load received by the motor model 71 from the mechanical model 72 when all simulation models 70 are detailed models if the motor-specific current I is the same. Therefore, the motor rotation speed N in the pre-simulation SM1a is the same as or substantially the same as the motor rotation speed N when all simulation models 70 are detailed models. As described above, the drive signal GS output from the detailed control model 74D in the pre-simulation SM1a using the simplified element model 76S is the same as or substantially the same as the drive signal GS when all simulation models 70 are detailed models. As used herein, the case where “a parameter is substantially the same as another parameter” includes that a difference between the parameter and the other parameter is small enough to be negligible as an error.

After saving the first time-series data DC1 in the storage 50, the arithmetic circuitry 40 generates the simplified control model 74S on the basis of the first time-series data DC1 (step S104). In step S104, the arithmetic circuitry 40 generates the simplified control model 74S with the model generator 41. In step S104, the model generator 41 generates a model from which the first time-series data DC1 saved in the storage 50 is output along the time series as the simplified control model 74S.

The arithmetic circuitry 40 generates the second simulation model 70B using the simplified control model 74S generated in step S104 (step S105). In step S105, the arithmetic circuitry 40 generates the second simulation model 70B with the model generator 41. In step S105, the model generator 41, for example, generates the second simulation model 70B by replacing the detailed control model 74D of the first simulation model 70A with the simplified control model 74S generated in step S104 and replacing the simplified inverter circuit model 73S of the first simulation model 70A with the detailed inverter circuit model 73D stored in the storage 50. In step S105, the model generator 41 may set the simplified inverter circuit model 73S to the detailed inverter circuit model 73D by replacing each simplified element model 76S of the simplified inverter circuit model 73S with the detailed element model 76D stored in the storage 50.

The arithmetic circuitry 40 performs the main simulation SM1b using the second simulation model 70B generated in step S105 (step S106). That is, executing the arithmetic operation in the first embodiment includes performing the main simulation SM1b using the second simulation model 70B. In the first embodiment, the arithmetic circuitry 40 performs the main simulation SM1b with the execution processor 42. Like the pre-simulation SM1a, the main simulation SM1b is simulation when the controller 64 drives the motor 61 in the first drive pattern DP1. The time step width in the main simulation SM1b is smaller than the time step width in the pre-simulation SM1a. The time step width in the main simulation SM1b is a fine time step width in a range that the behavior of the transient response during switching of the detailed element model 76D can be reproduced.

As shown in FIG. 4, in the main simulation SM1b, the inverter circuit model 73 is the detailed inverter circuit model 73D, the element model 76 is the detailed element model 76D, and the control model 74 is the simplified control model 74S. In the main simulation SM1b, the command signal CS, the motor-specific current I, and the motor rotation speed N are not input to the simplified control model 74S.

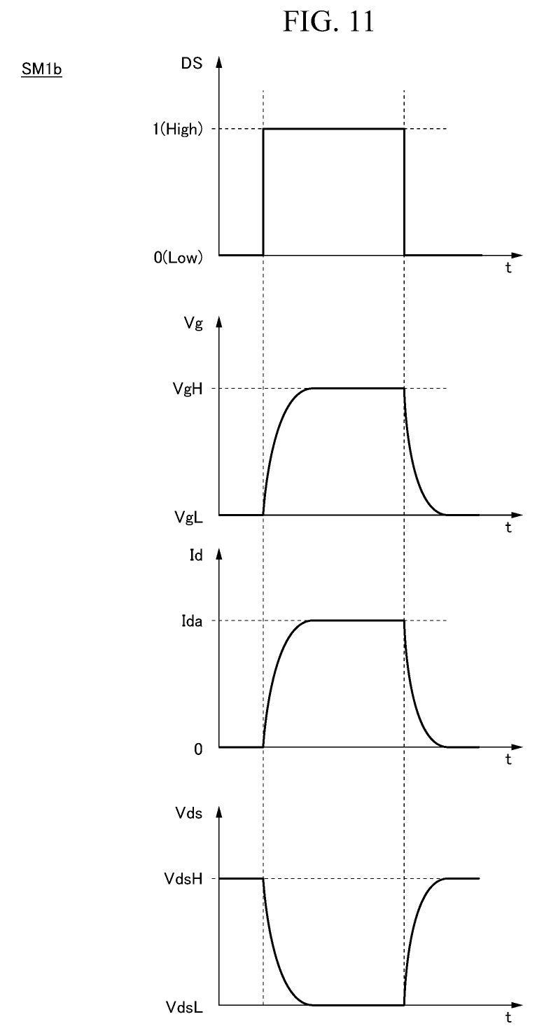

FIG. 11 is a diagram showing an example of a switching operation of the detailed element model 76D in the main simulation SM1b. A graph at the top of FIG. 11 shows the drive signal GS. A second graph from the top of FIG. 11 shows the gate voltage Vg of the detailed element model 76D. A third graph from the top of FIG. 11 shows the drain current Id flowing through the detailed element model 76D. A graph at the bottom of FIG. 11 shows the drain-source voltage Vds of the detailed element model 76D. In each graph of FIG. 11, the horizontal axis represents time t. The detailed element model 76D is a model in which the gate voltage Vg, the drain current Id, and the drain-source voltage Vds are reproduced together with the behavior of the transient response during switching as shown in FIG. 11 on the basis of the input drive signal GS.

As shown in FIG. 11, in the main simulation SM1b, even if the drive signal GS changes from 0 (low) to 1 (high), the gate voltage Vg does not instantaneously become a voltage VgH, but rises over time t to reach the voltage VgH in accordance with the value of the gate resistor model 76g or the like. In the main simulation SM1b, even if the drive signal GS changes from 1 to 0, the gate voltage Vg does not instantaneously become the voltage VgL, but decreases over time t to reach the voltage VgL. Values of the drain current Id and the drain-source voltage Vds also change over time t in accordance with the change in the gate voltage Vg when the drive signal GS is switched between 0 and 1. Although not shown in FIG. 11, noise generated during switching is also reproduced in the drain-source voltage Vds and the drain current Id in the main simulation SM1b.

When the main simulation SM1b is started, the simplified control model 74S outputs the drive signal GS of the first time-series data DC1 in time-series order. In the main simulation SM1b, the arithmetic circuitry 40 calculates the power loss occurring in the detailed element model 76D for each time step. The arithmetic circuitry 40 calculates the power loss by multiplying the drain current Id by the drain-source voltage Vds. The power loss calculated in the main simulation SM1b includes switching loss and conduction loss in the element model 76.

In the main simulation SM1b, the arithmetic circuitry 40 calculates a voltage value at a predetermined location of the second simulation model 70B and calculates a voltage waveform at the predetermined location. The predetermined location is not particularly limited as long as electromagnetic interference noise due to the voltage transient response generated in the switching operation of the detailed element model 76D can be detected.

As shown in FIG. 8, the arithmetic circuitry 40 outputs a result of the main simulation SM1b (step S107). The output result of the main simulation SM1b includes a graph showing a change in a temperature of the detailed element model 76D when the motor model 71 is driven in the first drive pattern DP1 and a graph showing a noise level of electromagnetic interference noise caused by the detailed element model 76D when the motor model 71 is driven in the first drive pattern DP1 for each frequency. The arithmetic circuitry 40 calculates the change in the temperature of the detailed element model 76D for each time step on the basis of the power loss in the detailed element model 76D calculated for each time step in the main simulation SM1b. The arithmetic circuitry 40 performs a fast Fourier transform (FFT) on the voltage waveform calculated in the main simulation SM1b and calculates the noise level for each frequency. The arithmetic circuitry 40 sequentially performs the fast Fourier transform on voltage waveforms for certain predetermined time ranges and calculates a maximum value of the noise level at each frequency as the noise level at the frequency.

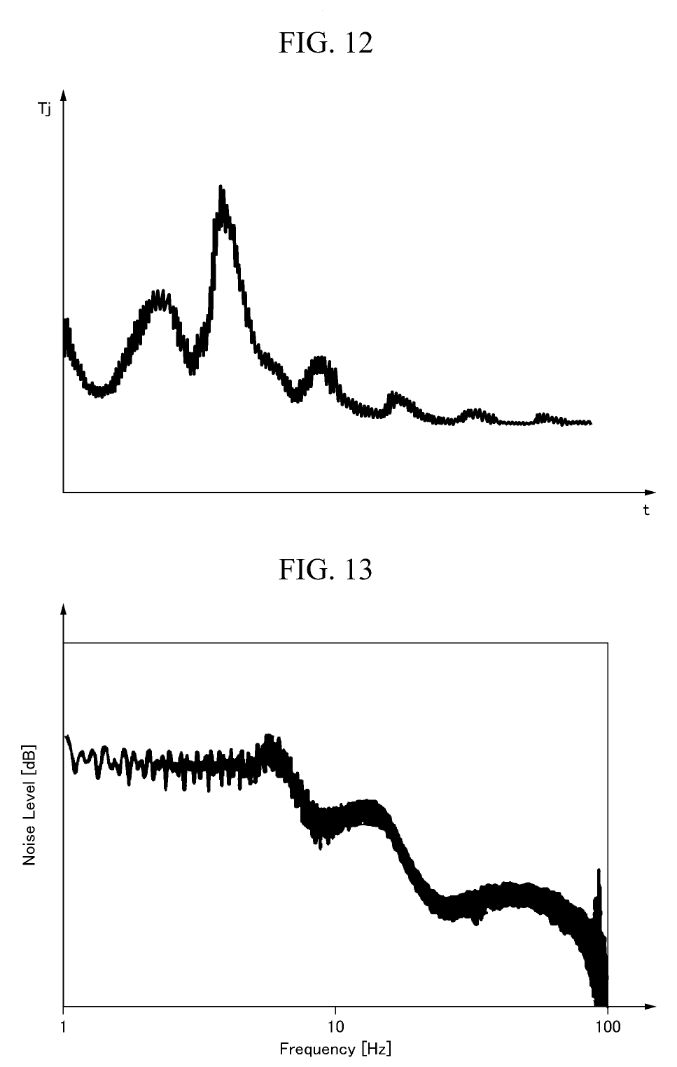

FIG. 12 is a graph showing an example of a change in a temperature in the element model 76 calculated in the main simulation SM1b. In FIG. 12, the vertical axis represents a temperature Tj of the element model 76 and the horizontal axis represents time t. FIG. 13 is a graph showing an example of the noise level of electromagnetic interference noise calculated in the main simulation SM1b. In FIG. 13, the vertical axis represents a noise level [dB] and the horizontal axis represents a frequency [Hz]. The noise level at each frequency in FIG. 13 is a maximum value of the noise level calculated for each frequency in the main simulation SM1b. The arithmetic circuitry 40 outputs graphs as shown in FIGS. 12 and 13 to the display 30 with the output circuitry 43. By looking at each graph displayed on the display 30, the user can acquire a simulation value of the change in the temperature of the switching element 66 and a simulation value of the noise level of electromagnetic interference noise when the motor 61 is driven in the first drive pattern DP1.

According to the first embodiment, the arithmetic method using the arithmetic device 100 is an arithmetic method of a computer, and includes executing an arithmetic operation including simulation using the simulation model 70 having the element model 76 corresponding to the switching element 66 and the control model 74 corresponding to the controller 64 that controls the motor 61 by driving the switching element 66. Executing the arithmetic operation includes performing the pre-simulation SM1a when the motor 61 is driven in the first drive pattern DP1 using the first simulation model 70A in which the element model 76 is the simplified element model 76S in which electrical characteristics of the switching element 66 are resistance characteristics, extracting the first time-series data DC1 of the drive signal GS output from the control model 74 in the pre-simulation SM1a, and performing the main simulation SM1b when the motor 61 is driven in the first drive pattern DP1 using the second simulation model 70B in which the control model 74 is the simplified control model 74S from which the first time-series data DC1 is output along a time series and in which the element model 76 is the detailed element model 76D in which power loss including switching loss that occurs when a state of the switching element 66 is switched can be output.

In the pre-simulation SM1a, because the element model 76 is the simplified element model 76S in which the electrical characteristics of the switching element 66 are resistance characteristics, an arithmetic operation is not performed for the transient response during switching of the switching element 66. Thereby, the arithmetic load in the pre-simulation SM1a is smaller than when the element model 76 is the detailed element model 76D. On the other hand, the drive signal GS output from the control model 74 changes on the basis of the motor-specific current I to be fed back as described above, but a change in the drain current Id in the transient response of the switching element 66 or the like has no influence on the motor-specific current I or is small enough to be negligible. Therefore, the first time-series data DC1 of the drive signal GS output from the control model 74 in the pre-simulation SM1a using the simplified element model 76S can be considered equivalent to the time-series data of the drive signal GS output from the control model 74 in the simulation when all simulation models 70 are detailed models. In the main simulation SM1b, the control model 74 is the simplified control model 74S from which the first time-series data DC1 is output along the time series, such that feedback control does not need to be executed in the control model 74 in the main simulation SM1b. Therefore, in the main simulation SM1b, the arithmetic load in the control model 74 can be reduced. Moreover, in the main simulation SM1b, the element model 76 is the detailed element model 76D capable of outputting power loss including switching loss that occurs when the state of the switching element 66 is switched. Therefore, it is possible to calculate the power loss occurring in the switching element 66 when the motor 61 is driven in the first drive pattern DP1 by inputting the drive signal GS of the first time-series data DC1 to the detailed element model 76D in time-series order. Because the power loss caused by the switching element 66 has the same value if the input to the switching element 66 is the same, it is possible to calculate the power loss as in the case where the control model 74 performs an arithmetic operation of feedback control in the pre-simulation SM1a by inputting the drive signal GS of the first time-series data DC1 to the detailed element model 76D with the simplified control model 74S.

As described above, according to the first embodiment, when the main simulation SM1b for reproducing the transient response during switching of the switching element 66 is performed, it is not necessary to perform an arithmetic operation related to feedback control by the control model 74. The arithmetic load of the arithmetic circuitry 40 when the transient response is reproduced during switching of the switching element 66 is larger than the arithmetic load of the arithmetic circuitry 40 when the other behavior of the switching element 66 is reproduced. Therefore, when the transient response is reproduced, if the control model 74 also performs an arithmetic operation related to feedback control, the arithmetic load of the arithmetic circuitry 40 increases synergistically. According to the first embodiment, in the pre-simulation SM1a for performing an arithmetic operation related to feedback control by the control model 74, the element model 76 is the simplified element model 76S and the transient response of the switching element 66 is not reproduced. Moreover, in the main simulation SM1b for calculating the power loss including switching loss during the transient response of the switching element 66 using the detailed element model 76D, the control model 74 is the simplified control model 74S from which the first time-series data DC1 obtained in the pre-simulation SM1a is output along the time series and the arithmetic operation related to the feedback control of the controller 64 is not reproduced. That is, an arithmetic operation for reproducing the transient response of the switching element 66 and an arithmetic operation for reproducing the feedback control of the controller 64 are not performed within single simulation. Therefore, it is possible to suppress a synergistic increase in the arithmetic load of the arithmetic circuitry 40 and reduce the arithmetic load of the arithmetic circuitry 40. Therefore, the time required for the simulation of the motor system 60 can be shortened. Moreover, it is possible to calculate the power loss as in the case where the entire simulation is performed using the detailed simulation model 70 by performing the main simulation SM1b using the simplified control model 74S from which the first time-series data DC1 is output along a time series. Therefore, it is possible to suppress a decrease in the accuracy of the simulation result of the change in the temperature of the switching element 66 based on the power loss. As described above, according to the first embodiment, it is possible to suppress a decrease in the accuracy of the result calculated by the simulation while shortening the time required for the simulation of the motor system 60.

According to the first embodiment, the time step width in the pre-simulation SM1a is larger than the time step width in the main simulation SM1b. Thus, the time required for the pre-simulation SM1a can be further shortened. Therefore, the time required for the entire simulation of the motor system 60 can be further shortened. For example, when the time step width in the pre-simulation SM1a is 10 times or more the time step width in the main simulation SM1b, the time required for the pre-simulation SM1a can be more suitably shortened.

According to the first embodiment, the arithmetic device 100 includes the arithmetic circuitry 40 configured to execute an arithmetic operation including simulation using the simulation model 70 having the element model 76 corresponding to the switching element 66 and the control model 74 corresponding to the controller 64 that controls the motor 61 by driving the switching element 66. The arithmetic circuitry 40 performs the pre-simulation SM1a when the motor 61 is driven in the first drive pattern DP1 using the first simulation model 70A in which the element model 76 is the simplified element model 76S in which electrical characteristics of the switching element 66 are resistance characteristics and extracts the first time-series data DC1 of the drive signal GS output from the control model 74 in the pre-simulation SM1a. The arithmetic circuitry 40 performs the main simulation SM1b when the motor 61 is driven in the first drive pattern DP1 using the second simulation model 70B in which the control model 74 is the simplified control model 74S from which the first time-series data DC1 is output along a time series and in which the element model 76 is the detailed element model 76D in which power loss including switching loss that occurs when a state of the switching element 66 is switched can be output. According to this arithmetic device 100, the above-described arithmetic method can be executed and the time required for simulation of the motor system 60 can be shortened.

### Second Embodiment

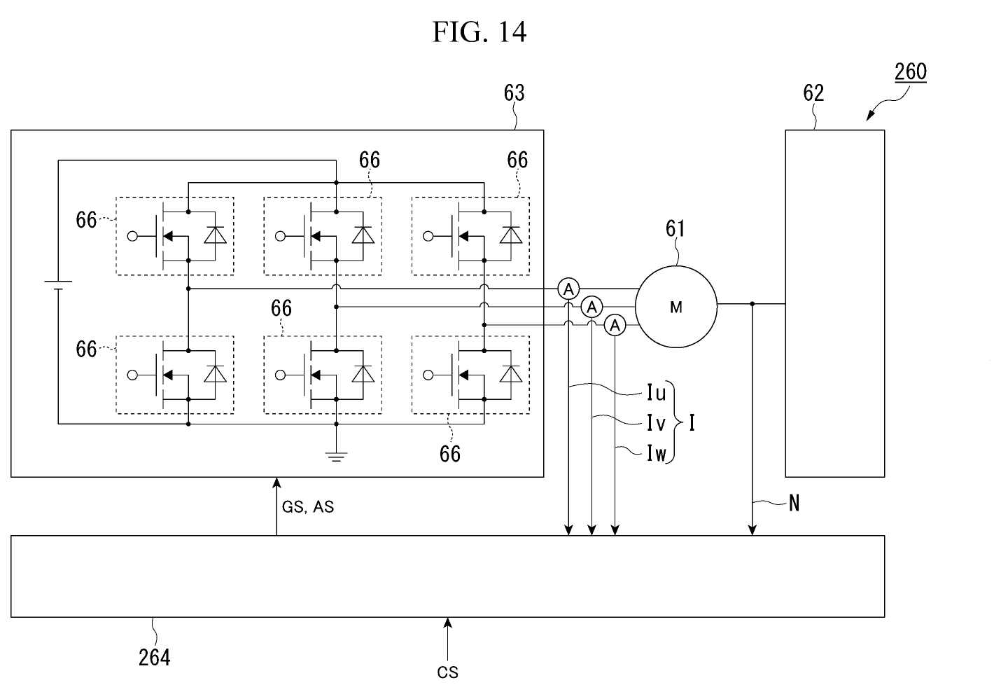

In the following description, the same reference signs are assigned for a configuration and method similar to those of the above-described embodiment and their description may be omitted. FIG. 14 is a diagram showing an example of a motor system 260 serving as a simulation target in a second embodiment.

As shown in FIG. 14, a controller 264 in the motor system 260 inputs a drive capability control signal AS to a switching element 66 of an inverter circuit 63. The drive capability control signal AS is a signal for changing characteristics of the switching element 66. In the second embodiment, the drive capability control signal AS is a signal for changing a resistance value of a gate resistor connected to the gate of the switching element 66. The controller 264 adjusts the drive capability control signal AS output to the switching element 66 on the basis of, for example, a magnitude of a motor-specific current I.

For example, when the motor-specific current I is equal to or greater than a certain value, the controller 264 outputs the drive capability control signal AS for increasing the resistance value of the gate resistor to the switching element 66. When the motor-specific current I increases to a certain extent, the conduction loss in the switching element 66 becomes larger than the switching loss. In this case, even if the switching loss increases when the resistance value of the gate resistor increases and the transient response time increases, the influence on the power loss occurring in the switching element 66 is small. Therefore, when the motor-specific current I is equal to or greater than a certain value, the controller 264 reduces electromagnetic interference noise by increasing the resistance value of the gate resistor and moderating the change in the drain-source voltage Vds during switching.

For example, when the motor-specific current I is less than the certain value, the controller 264 outputs the drive capability control signal AS for decreasing the resistance value of the gate resistor to the switching element 66. When the motor-specific current I decreases to a certain extent, the switching loss in the switching element 66 becomes larger than the conduction loss. Therefore, when the time required for the transient response during switching becomes longer and the switching loss generated in the switching element 66 increases, an influence on the power loss generated in the switching element 66 is large. Therefore, when the motor-specific current I is less than the certain value, the controller 264 reduces the switching loss by reducing the resistance value of the gate resistor and shortening the transient response time during switching. Other aspects of the motor system 260 are similar to those of the motor system 60 in the first embodiment.

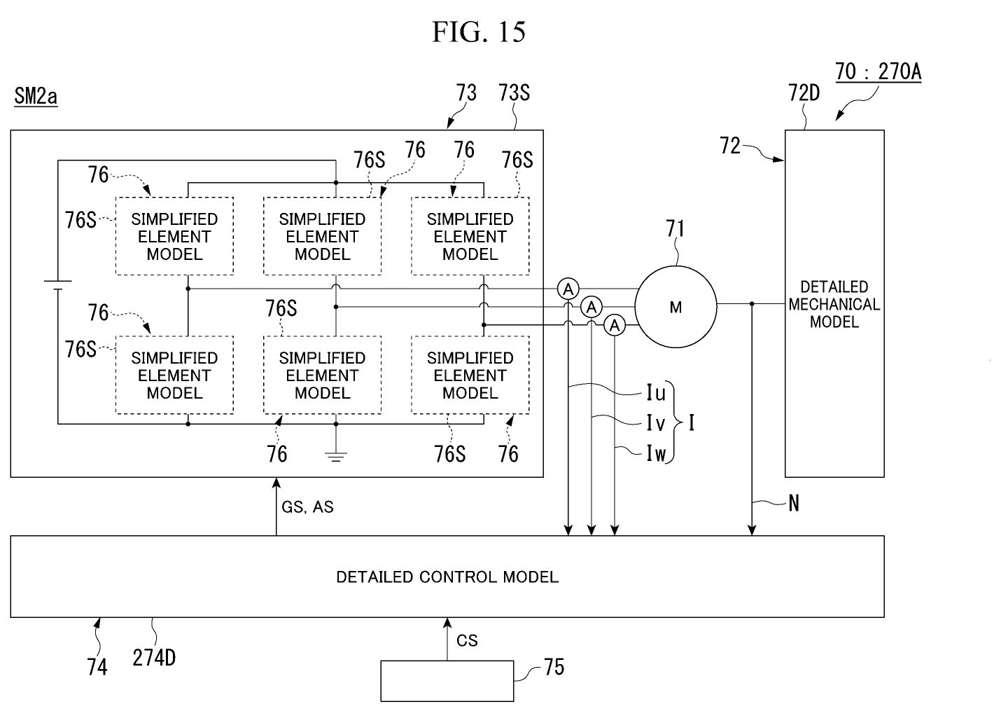

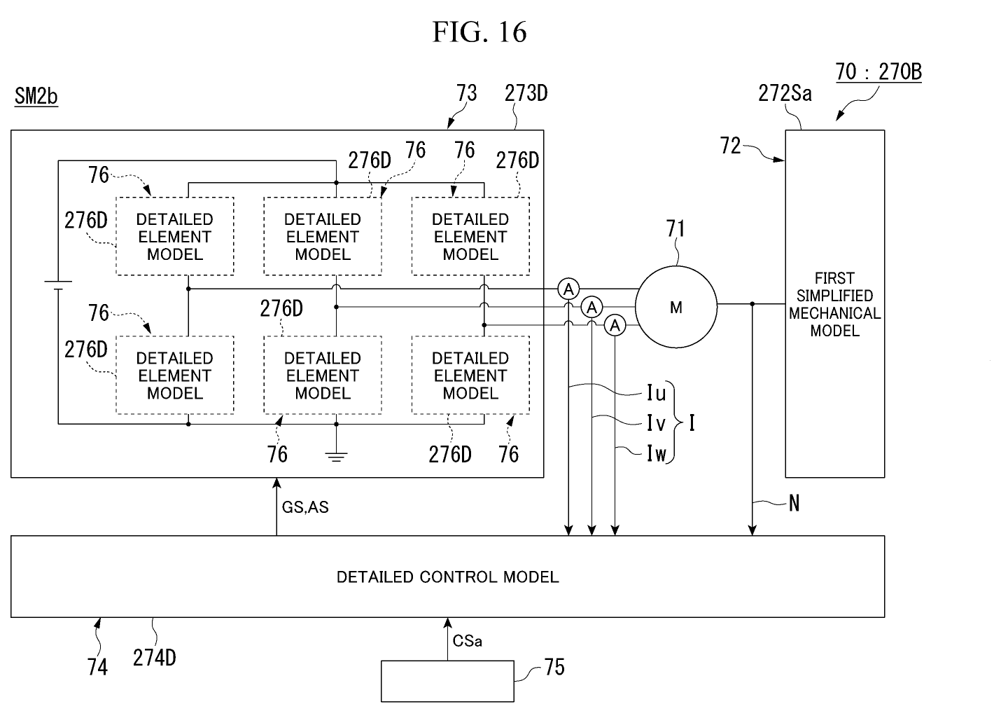

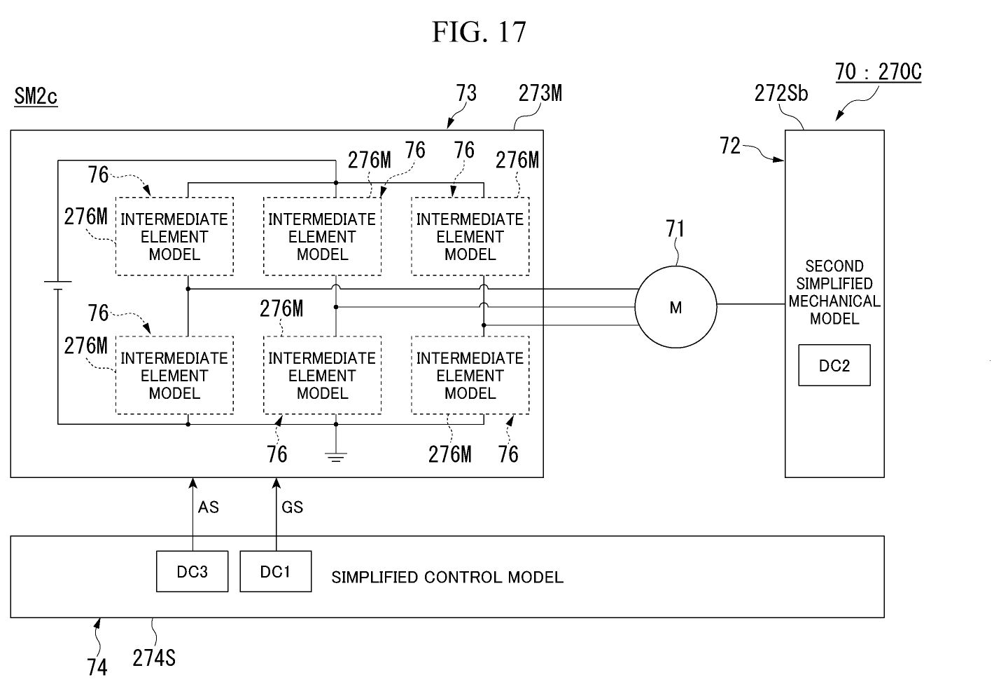

FIG. 15 is a diagram showing an example of a simulation model 70 in the second embodiment. FIG. 16 is a diagram showing another example of the simulation model 70 in the second embodiment. FIG. 17 is a diagram showing yet another example of the simulation model 70 in the second embodiment. In the second embodiment, a model generator 41 of an arithmetic circuitry 40 generates three simulation models 70, i.e., a first simulation model 270A shown in FIG. 15, a second simulation model 270B shown in FIG. 16, and a third simulation model 270C shown in FIG. 17.

As shown in FIG. 15, in the first simulation model 270A, an element model 76 is a simplified element model 76S and an inverter circuit model 73 is a simplified inverter circuit model 73S. In the first simulation model 270A, a control model 74 is a detailed control model 274D. The detailed control model 274D is similar to the detailed control model 74D in the first embodiment, except that a drive capability control signal AS is output to the simplified inverter circuit model 73S. Other aspects of the first simulation model 270A are similar to those of the first simulation model 70A in the first embodiment.

As shown in FIG. 16, in the second simulation model 270B, the element model 76 is a detailed element model 276D and the inverter circuit model 73 is a detailed inverter circuit model 273D. The detailed element model 276D is different from the detailed element model 76D in the first embodiment shown in FIG. 5 in that a gate resistor model 76g is a variable resistor whose resistance value changes with the drive capability control signal AS. Other aspects of the detailed element model 276D are similar to those of the detailed element model 76D in the first embodiment. In the second simulation model 270B, the control model 74 is a detailed control model 274D. In the second simulation model 270B, a mechanical model 72 is a first simplified mechanical model 272Sa. In the second embodiment, the first simplified mechanical model 272Sa is a model from which a load due to viscous resistance proportional to a motor rotation speed N is output to a motor model 71. The first simplified mechanical model 272Sa, for example, is stored in a storage 50 in advance. The second simulation model 270B includes a command value input circuitry 75.

As shown in FIG. 17, in the third simulation model 270C, the element model 76 is an intermediate element model 276M. Like the simplified element model 76S, the intermediate element model 276M is a model in which a gate voltage Vg, a drain current Id, and a drain-source voltage Vds change with respect to a drive signal GS as shown in FIG. 10. The intermediate element model 276M is a model from which power loss corresponding to the motor-specific current I is output on the basis of a heat table HT created in table generation simulation SM2b to be described below during switching. That is, in the second embodiment, the intermediate element model 276M is a model in which power loss including switching loss that occurs when the state of the switching element 66 is switched can be output. The intermediate element model 276M is similar to the simplified element model 76S, except that a function of outputting the power loss is provided. In the second embodiment, the intermediate element model 276M is a model from which power loss including switching loss and conduction loss is output. In the third simulation model 270C, the inverter circuit model 73 is an intermediate inverter circuit model 273M in which each element model 76 is the intermediate element model 276M.

In the third simulation model 270C, the control model 74 is a simplified control model 274S. The simplified control model 274S outputs third time-series data DC3 extracted in pre-simulation SM2a to be described below along a time series regardless of any input from other models. Other aspects of the simplified control model 274S are similar to those of the simplified control model 74S in the first embodiment.

In the third simulation model 270C, the mechanical model 72 is a second simplified mechanical model 272Sb. The second simplified mechanical model 272Sb is a model from which second time-series data DC2 extracted in the pre-simulation SM2a to be described below is output to the motor model 71 along a time series regardless of any input from other models or the like. The third simulation model 270C does not have any command value input circuitry 75.

In the second embodiment, an execution processor 42 of the arithmetic circuitry 40 can execute the pre-simulation SM2a using the first simulation model 270A, the table generation simulation SM2b using the second simulation model 270B, and a main simulation SM2c using the third simulation model 270C. In the second embodiment, the pre-simulation SM2a corresponds to “first simulation.” In the second embodiment, the table generation simulation SM2b corresponds to “third simulation.” In the second embodiment, the main simulation SM2c corresponds to “second simulation.”

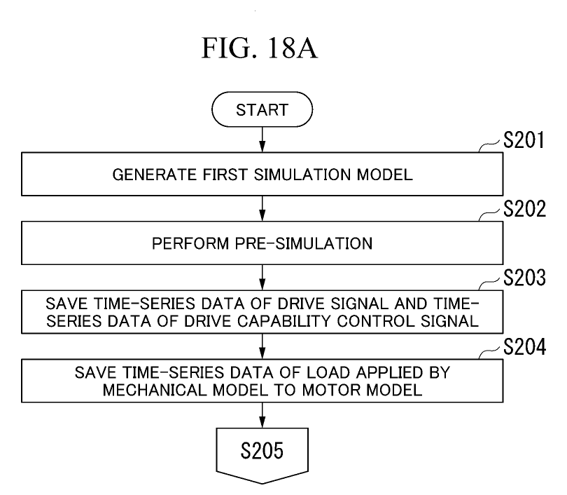

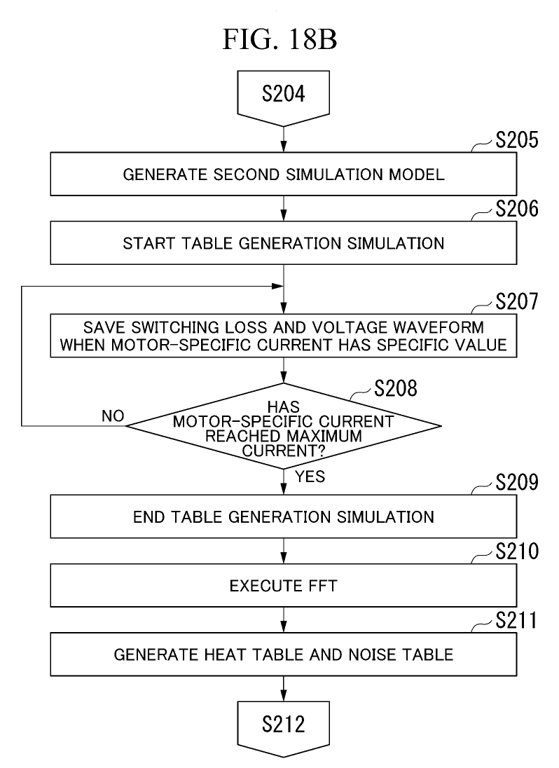

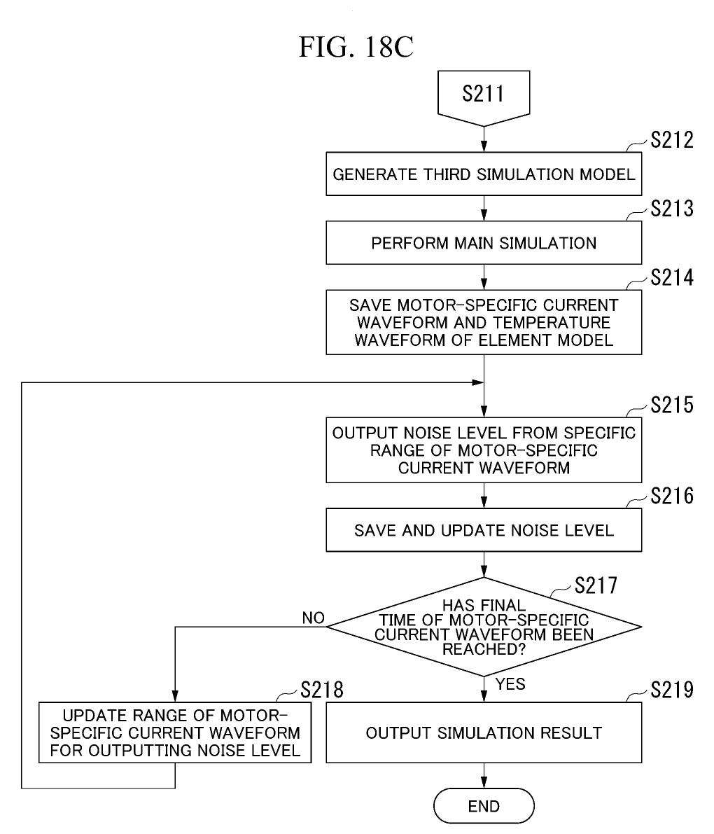

FIG. 18A is a flowchart showing a part of an example of a process executed by the arithmetic circuitry 40 in the second embodiment. FIG. 18B is a flowchart showing another part of the example of the process executed by the arithmetic circuitry 40 in the second embodiment. FIG. 18C is a flowchart showing yet another part of the example of the process executed by the arithmetic circuitry 40 in the second embodiment. The flow of the process shown in FIGS. 18A to 18C is a flow in which simulation for the case where the motor 61 in the motor system 260 is driven in the first drive pattern DP1 is executed and a process of estimating a change in a temperature of the switching element 66 and a noise level of electromagnetic interference noise occurring in the motor system 260 caused by the switching element 66 is performed by the simulation.

As shown in FIG. 18A, the arithmetic circuitry 40 generates the first simulation model 270A (step S201). In the second embodiment, the arithmetic circuitry 40 generates the first simulation model 270A with the model generator 41. The arithmetic circuitry 40 generates the first simulation model 270A as in step S101 of the first embodiment. The arithmetic circuitry 40 performs the pre-simulation SM2a using the first simulation model 270A (step S202). The pre-simulation SM2a is simulation in which the controller 264 drives the motor 61 in the first drive pattern DP1. The arithmetic circuitry 40 performs the pre-simulation SM2a as in step S102 of the first embodiment. The time step width in the pre-simulation SM2a, for example, is larger than the time step width in the table generation simulation SM2b. The time step width in the pre-simulation SM2a is, for example, about 5 times or more and 30 times or less the time step width in the table generation simulation SM2b.

The arithmetic circuitry 40 saves time-series data of the drive signal GS and time-series data of the drive capability control signal AS output from the detailed control model 274D in the pre-simulation SM2a (step S203). In step S203, the arithmetic circuitry 40 saves the time-series data of the drive signal GS and the time-series data of the drive capability control signal AS output from the detailed control model 274D in the storage 50, for example, via an output circuitry 43. The time-series data of the drive signal GS output from the detailed control model 274D is the first time-series data DC1. The time-series data of the drive capability control signal AS output from the detailed control model 274D is the third time-series data DC3. The third time-series data DC3 includes time-series data of drive capability control signals AS input to a plurality of simplified element models 76S in the pre-simulation SM2a. Thus, executing the arithmetic operation in the arithmetic method of the second embodiment includes extracting the third time-series data DC3 of the drive capability control signal AS output from the control model 74 in the pre-simulation SM2a.

Here, in the pre-simulation SM1a, the drive capability control signal AS output from the detailed control model 74D is decided on the basis of the motor-specific current I to be fed back. As described above, the magnitude of the motor-specific current I is unaffected or substantially unaffected by an instantaneous change in the drain current Id in the transient response when the switching element 66 is switched. Therefore, even if the element model 76 is the simplified element model 76S incapable of reproducing the electrical characteristics of the transient response during switching in the pre-simulation SM2a, the motor-specific current I output from the inverter circuit model 73 is the same as or substantially the same as when the element model 76 is a detailed element model 76D capable of reproducing the electrical characteristics of the transient response during switching. Therefore, even in the pre-simulation SM2a using the simplified element model 76S, the drive capability control signal AS that changes on the basis of the motor-specific current I is the same as or substantially the same as the drive capability control signal AS for a case where all simulation models 70 are detailed models.

The arithmetic circuitry 40 saves time-series data of a load applied by the detailed mechanical model 72D to the motor model 71 in the pre-simulation SM2a (step S204). The time-series data of the load applied by the detailed mechanical model 72D to the motor model 71 is the second time-series data DC2. The second time-series data DC2 is data indicating a torque waveform output from the motor model 71. The arithmetic circuitry 40, for example, saves the second time-series data DC2 in the storage 50 via the output circuitry 43. Thus, executing the arithmetic operation in the arithmetic method of the second embodiment includes extracting the second time-series data DC2 of the load that the mechanical model 72 gives to the motor model 71 in the pre-simulation SM2a. In addition, either step S203 or step S204 may be performed first or step S203 and step S204 may be performed at the same time.

As shown in FIG. 18B, the arithmetic circuitry 40 generates the second simulation model 270B after step S204 (step S205). In step S205, the model generator 41 of the arithmetic circuitry 40, for example, generates the second simulation model 270B by replacing the simplified inverter circuit model 73S of the first simulation model 270A with the detailed inverter circuit model 273D stored in the storage 50 in advance described above and replacing the mechanical model 72 of the first simulation model 270A with the first simplified mechanical model 272Sa stored in the storage 50 in advance described above. In step S205, the model generator 41 may make a change from the simplified inverter circuit model 73S to the detailed inverter circuit model 273D by replacing the simplified element model 76S of the simplified inverter circuit model 73S with the detailed element model 276D.

The arithmetic circuitry 40 starts the table generation simulation SM2b using the second simulation model 270B generated in step S205 (step S206). That is, executing the arithmetic in the arithmetic method of the second embodiment includes setting the mechanical model 72 in the table generation simulation SM2b to the first simplified mechanical model 272Sa from which a load corresponding to the rotation speed of the motor model 71 is output to the motor model 71.

The table generation simulation SM2b is simulation in which the controller 264 drives the motor 61 in the second drive pattern DP2. The second drive pattern DP2 is a drive pattern in which the motor-specific current I changes. In the second embodiment, the second drive pattern DP2 is a drive pattern in which the motor-specific current I is raised from zero to the maximum current allowed in the motor system 260. That is, executing the arithmetic operation in the arithmetic method of the second embodiment includes performing the table generation simulation SM2b when the motor 61 is driven in the second drive pattern DP2 in which the motor-specific current I changes using the second simulation model 270B after the pre-simulation SM1a is executed and before the main simulation SM2c is executed.

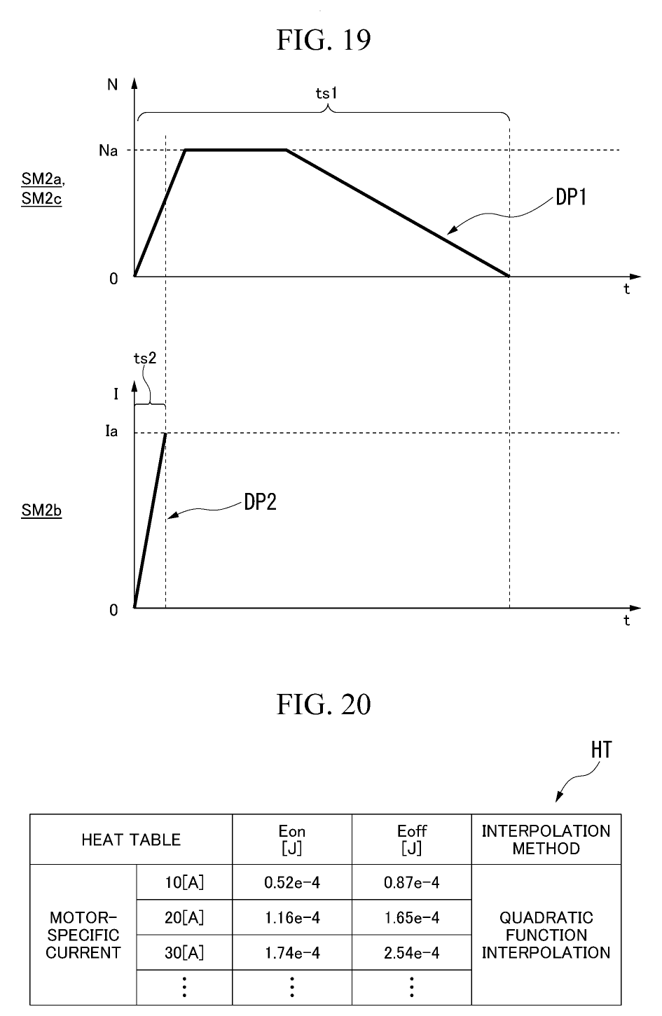

FIG. 19 is a graph showing an example of the first drive pattern DP1 and an example of the second drive pattern DP2. An upper graph of FIG. 19 shows the first drive pattern DP1. A lower graph of FIG. 19 shows the second drive pattern DP2. In the upper graph of FIG. 19, the vertical axis represents the motor rotation speed N and the horizontal axis represents time t. In the lower graph of FIG. 19, the vertical axis represents the motor-specific current I, and the horizontal axis represents time t. In the example of FIG. 19, the first drive pattern DP1 is similar to the first drive pattern DP1 in the first embodiment. The second drive pattern DP2 shown in the example of FIG. 19 is a drive pattern in which the motor-specific current I is increased from zero to the maximum current Ia. Time ts2 in which the motor 61 is driven in the second drive pattern DP2 is shorter than time ts1 in which the motor 61 is driven in the first drive pattern DP1. The time ts2 is, for example, one-tenth or less of the time ts1. In addition, in the example of FIG. 19, the second drive pattern DP2 is shown as a pattern in which the motor-specific current I rises linearly, but strictly speaking, the second drive pattern DP2 is a drive pattern in which an amplitude value of the motor-specific current I that is an alternating current monotonically increases over time t. The waveform of the motor-specific current I shown in the lower graph of FIG. 19 may be a waveform of an effective value of the motor-specific current I.

As shown in FIG. 16, in the table generation simulation SM2b, the inverter circuit model 73 is the detailed inverter circuit model 273D, the element model 76 is the detailed element model 276D, the control model 74 is the detailed control model 274D, and the mechanical model 72 is the first simplified mechanical model 272Sa. A command signal CSa necessary for driving the motor 61 in the second drive pattern DP2 is input from the command value input circuitry 75 to the detailed control model 274D in the table generation simulation SM2b. In the table generation simulation SM2b, the motor-specific current I and the motor rotation speed N are fed back to the detailed control model 274D. The time step width in the table generation simulation SM2b is smaller than the time step width in the pre-simulation SM2a. The time step width in the table generation simulation SM2b is a time step width so fine that the behavior of the transient response during switching of the detailed element model 276D can be reproduced.

As shown in FIG. 18B, when the table generation simulation SM2b is started, the arithmetic circuitry 40 saves switching loss occurring in the detailed element model 276D when the motor-specific current I has a specific value and a voltage waveform of a voltage at a predetermined location in the second simulation model 270B (step S207). That is, executing the arithmetic operation in the arithmetic method of the second embodiment includes calculating a voltage value at the predetermined location of the second simulation model 270B in the table generation simulation SM2b. In step S207, the arithmetic circuitry 40 saves the switching loss and voltage waveform in the storage 50 via the output circuitry 43. In step S207, the arithmetic circuitry 40 saves each of a value of switching loss occurring in the detailed element model 276D when the detailed element model 276D is turned on from the OFF state to the ON state and a value of switching loss occurring in the detailed element model 276D when the detailed element model 276D is turned off from the ON state to the OFF state.

Here, the detailed element model 276D is a model in which the gate voltage Vg, the drain current Id, and the drain-source voltage Vds are reproduced together with the behavior of the transient response during switching as shown in FIG. 11 on the basis of the input drive signal GS. In step S207, the arithmetic circuitry 40 calculates the switching loss during switching by multiplying the drain-source voltage Vds in the transient response during switching by the drain current Id in the transient response during switching.

The predetermined location at which the voltage of the voltage waveform saved in step S207 is calculated is not particularly limited as long as electromagnetic interference noise due to the transient response of the voltage generated in the switching operation of the detailed element model 276D can be detected.

In the table generation simulation SM2b, step S207 is executed every time the motor-specific current I rises at a predetermined interval. For example, the predetermined interval is 10 [A]. In this case, step S207 is executed every time the motor-specific current I is raised by 10 [A]. The arithmetic circuitry 40 determines whether or not the motor-specific current I has reached the maximum current Ia (step S208) and continuously executes step S207 until it is determined that the motor-specific current I has not reached the maximum current Ia. When it is determined that the motor-specific current I has reached the maximum current Ia (step S208: YES), the arithmetic circuitry 40 ends the table generation simulation SM2b (step S209). In addition, the value of the motor-specific current I used in steps S207 and S208 may be the value of the amplitude of the motor-specific current I or the effective value of the motor-specific current I.

After the table generation simulation SM2b ends, the arithmetic circuitry 40 executes a fast Fourier transform on the voltage waveform saved in step S207 (step S210). The arithmetic circuitry 40 calculates a noise level of the electromagnetic interference noise for a frequency for each specific value of the motor-specific current I by performing the fast Fourier transform on a voltage waveform saved for each specific value of the motor-specific current I.

After the fast Fourier transform is performed in step S210, the arithmetic circuitry 40 generates a heat table HT and a noise table NT (step S211). In step S211, the arithmetic circuitry 40 generates the heat table HT on the basis of the switching loss saved for each specific motor-specific current I in step S207. In the second embodiment, the heat table HT corresponds to a “first relationship” between the motor-specific current I and the switching loss. That is, executing the arithmetic operation in the arithmetic method of the second embodiment includes calculating the heat table HT as a first relationship between the motor-specific current I and the switching loss on the basis of the switching loss in the element model 76 calculated in the table generation simulation SM2b.

FIG. 20 is a diagram showing an example of the heat table HT. As shown in FIG. 20, in the heat table HT, a value of switching loss Eon [J] per second generated in the detailed element model 276D when the detailed element model 276D is turned on and a value of switching loss Eoff [J] per second generated in the detailed element model 276D when the detailed element model 276D is turned off are stored in association with each other for each value of the motor-specific current I. For example, in FIG. 20, if the motor-specific current I is 10 [A], when the detailed element model 276D is turned on, it is indicated that a switching loss Eon of 0.52×10⁻⁴ [J] per second occurs. By multiplying the switching loss Eon by the switching time, the switching loss occurring in the detailed element model 276D when the detailed element model 276D is turned on is calculated. The switching loss occurring in the detailed element model 276D when the detailed element model 276D is turned off is calculated by multiplying the switching loss Eoff by the switching time. An “interpolation method” shown in the heat table HT is an interpolation method used in calculating the switching loss in the value of the motor-specific current I other than the value shown in the heat table HT. The relationship between the motor-specific current I and the switching loss is, for example, nonlinear. Therefore, when the switching loss Eon or Eoff at a value of the motor-specific current I other than those shown in the heat table HT is calculated, the arithmetic circuitry 40 calculates the switching loss Eon or Eoff according to nonlinear interpolation using a quadratic function. In addition, when a relationship between the motor-specific current I and the switching loss is linear, the arithmetic circuitry 40 may calculate the switching loss by linear interpolation instead of nonlinear interpolation. The value of the motor-specific current I in the heat table HT may be the value of the amplitude of the motor-specific current I or the effective value of the motor-specific current I.

In step S211, the arithmetic circuitry 40 generates the noise table NT on the basis of the noise level for a frequency calculated for each specific motor-specific current I in step S210. The noise table NT corresponds to a “second relationship” between the motor-specific current I and the noise level. That is, executing the arithmetic operation in the arithmetic method of the second embodiment includes calculating the noise table NT as the second relationship between the motor-specific current I and the noise level of the electromagnetic interference noise generated in the simulation model 70 on the basis of the voltage value calculated in the table generation simulation SM2b.

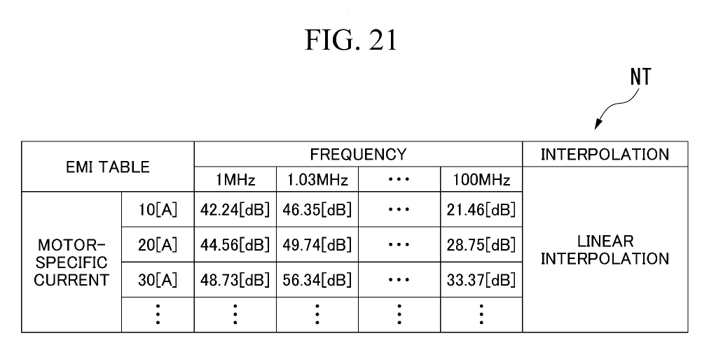

FIG. 21 is a diagram showing an example of the noise table NT. As shown in FIG. 21, in the noise table NT, a noise level for each predetermined frequency and each value of the motor-specific current I are stored in association with each other. For example, as shown in FIG. 21, when the motor-specific current I is 10 [A], the noise level at a frequency of 1 MHz is 42.24 [dB]. The “interpolation method” shown in the noise table NT is an interpolation method used in calculating the noise level in the value of the motor-specific current I other than the value shown in the noise table NT. A relationship between the motor-specific current I and the noise level is, for example, linear. Therefore, when the noise level at the value of the motor-specific current I other than the value shown in the noise table NT is calculated, the arithmetic circuitry 40 calculates the noise level by linear interpolation. In addition, when the relationship between the motor-specific current I and the noise level is nonlinear, the arithmetic circuitry 40 may calculate the noise level by nonlinear interpolation using a quadratic function or the like instead of linear interpolation. The value of the motor-specific current I in the noise table NT may be the value of the amplitude of the motor-specific current I or may be the effective value of the motor-specific current I.

As shown in FIG. 18C, after step S211, the arithmetic circuitry 40 generates the third simulation model 270C (step S212). In step S212, the arithmetic circuitry 40 generates the intermediate element model 276M. The intermediate element model 276M is a model from which power loss including switching loss corresponding to the motor-specific current I is output on the basis of the heat table HT. In step S212, the arithmetic circuitry 40 generates the simplified control model 274S. The simplified control model 274S is a model in which the first time-series data DC1 and the third time-series data DC3 are output along a time series. In step S212, the arithmetic circuitry 40 generates the second simplified mechanical model 272Sb. The second simplified mechanical model 272Sb is a model from which the second time-series data DC2 is output to the motor model 71 along the time series. In addition, the arithmetic circuitry 40 may generate the simplified control model 274S at a timing prior to step S212 after the first time-series data DC1 and the third time-series data DC3 are extracted. Moreover, the arithmetic circuitry 40 may generate the second simplified mechanical model 272Sb at a timing prior to step S212 after the second time-series data DC2 is extracted.

In step S212, the arithmetic circuitry 40, for example, generates the third simulation model 270C by replacing the element model 76 with the intermediate element model 276M, replacing the control model 74 with the simplified control model 274S, and replacing the mechanical model 72 with the second simplified mechanical model 272Sb. The arithmetic circuitry 40 performs the main simulation SM2c using the generated third simulation model 270C (step S213). That is, executing the arithmetic operation in the arithmetic method of the second embodiment includes setting the element model 76 in the main simulation SM2c to the intermediate element model 276M, setting the control model 74 in the main simulation SM2c to the simplified control model 274S, and setting the mechanical model 72 in the main simulation SM2c to the second simplified mechanical model 272Sb.

The main simulation SM2c is simulation in which the controller 264 drives the motor 61 in the first drive pattern DP1. The time step width in the main simulation SM2c is larger than the time step width in the table generation simulation SM2b. The time step width in the main simulation SM2c is a coarse time step width within a range in which the temperature change in the intermediate element model 276M can be reproduced. The time step width in the main simulation SM2c is, for example, about 5 times or more and 30 times or less the time step width in the table generation simulation SM2b. The time step width in the main simulation SM2c is, for example, the time step width in the pre-simulation SM2a. The time step width in the main simulation SM2c may be larger than the time step width in the pre-simulation SM2a or may be smaller than the time step width in the pre-simulation SM2a.

The arithmetic circuitry 40 calculates a change of the motor-specific current I over time in the main simulation SM2c. The arithmetic circuitry 40 calculates a change in a temperature of the element model 76 over time in the main simulation SM2c. The temperature of the element model 76 changes with an integrated value of power generated in the element model 76. The arithmetic circuitry 40 calculates the change in the temperature of the intermediate element model 276M on the basis of the power loss value output from the intermediate element model 276M in the main simulation SM2c. In addition, the intermediate element model 276M may be a model from which power loss including switching loss without including conduction loss is output. In this case, the arithmetic circuitry 40 may calculate the conduction loss from the drain current Id and the resistance value of the intermediate element model 276M and calculate power loss occurring in the intermediate element model 276M on the basis of the conduction loss and the switching loss output from the intermediate element model 276M in the main simulation SM2c.

After the main simulation SM2c is performed, the arithmetic circuitry 40 saves a motor-specific current waveform and a temperature waveform of the element model 76 (step S214). The motor-specific current waveform is a waveform of the motor-specific current I that changes over time in the main simulation SM2c. The temperature waveform of the element model 76 is a waveform of the temperature of the element model 76 that changes over time in the main simulation SM2c. In step S214, the arithmetic circuitry 40 saves the motor-specific current waveform and the temperature waveform of the element model 76 in the storage 50.

After the motor-specific current waveform and the temperature waveform of the element model 76 are saved, the arithmetic circuitry 40 outputs a noise level from a specific range of the motor-specific current waveform (step S215). In step S215, the arithmetic circuitry 40 outputs a noise level corresponding to a value of the motor-specific current I for each time for each frequency on the basis of the noise table NT. That is, executing the arithmetic operation in the second embodiment includes calculating the noise level in the main simulation SM2c on the basis of the noise table NT as the second relationship and the motor-specific current I output in the main simulation SM2c. The arithmetic circuitry 40 saves the output noise level for each frequency (step S216). At this time, when the noise level saved at a certain frequency already exists, the arithmetic circuitry 40 compares the saved noise level with the currently output noise level. When the currently output noise level is greater than the saved noise level, the arithmetic circuitry 40 updates the noise level at the frequency to the currently output noise level. When the currently output noise level is less than or equal to the saved noise level, the arithmetic circuitry 40 does not change the noise level saved for the frequency. By performing the processing of step S216 on all saved motor-specific current waveforms, the maximum value of the noise level is calculated for each frequency. This arithmetic method is, for example, referred to as a maximum value holding method (a max-hold method).

After saving or updating the noise level output from the specific range of the motor-specific current waveform, the arithmetic circuitry 40 determines whether or not the specific range of the motor-specific current waveform for outputting the noise level has reached the final time of the motor-specific current waveform (step S217). When it is determined that the specific range of the motor-specific current waveform that outputs the noise level has not reached the final time of the motor-specific current waveform (step S217: NO), the arithmetic circuitry 40 updates the range of the motor-specific current waveform for outputting the noise level to the next time range (step S218), and executes steps S215 and S216 again. When it is determined that the specific range of the motor-specific current waveform for outputting the noise level has reached the final time of the motor-specific current waveform (step S217: YES), the arithmetic circuitry 40 outputs a simulation result (step S219). In the second embodiment, the simulation result output by the arithmetic circuitry 40 includes a graph showing a change in the temperature of the element model 76 over time as exemplified in FIG. 12 and a graph showing a noise level for each frequency as exemplified in FIG. 13. The simulation result is displayed on the display 30 via the output circuitry 43.

According to the second embodiment, the control target of the controller 264 is the motor 61 to which the motor-specific current I is supplied from the inverter circuit 63 having the plurality of switching elements 66. The simulation model 70 includes the inverter circuit model 73 having the plurality of element models 76 corresponding to the inverter circuit 63 and the motor model 71 corresponding to the motor 61. Executing the arithmetic operation includes performing the table generation simulation SM2b when the motor 61 is driven in the second drive pattern DP2 in which the motor-specific current I changes using the second simulation model 270B in which the element model 76 is the detailed element model 276D in which electrical characteristics in a transient response when the state of the switching element 66 is switched can be reproduced after the pre-simulation SM2a is executed and before the main simulation SM2c is executed. Executing the arithmetic operation includes calculating the heat table HT as a first relationship between the motor-specific current I and the switching loss on the basis of the switching loss in the element model 76 calculated in the table generation simulation SM2b. Executing the arithmetic operation includes setting the element model 76 in the main simulation SM2c to the intermediate element model 276M from which the power loss including the switching loss corresponding to the motor-specific current I is output on the basis of the heat table HT. A period of time in which the motor 61 is driven in the second drive pattern DP2 is shorter than a period of time in which the motor 61 is driven in the first drive pattern DP1.

Here, because there is a correlation between the motor-specific current I and the switching loss, it is possible to calculate the switching loss on the basis of the motor-specific current I and the heat table HT by calculating the heat table HT as the first relationship in the table generation simulation SM2b. It is possible to calculate the power loss in the element model 76 without reproducing the transient response during switching of the switching element 66 in the main simulation SM2c by setting the element model 76 in the main simulation SM2c to the intermediate element model 276M in which power loss including switching loss can be output on the basis of the heat table HT. Therefore, it is possible to reduce the arithmetic load of the arithmetic circuitry 40 in the main simulation SM2c when the motor 61 is driven in the first drive pattern DP1. Thereby, the time required for the main simulation SM2c can be shortened. Although it is necessary to reproduce the transient response during switching of the switching element 66 in the table generation simulation SM2b, it is only necessary to obtain the heat table HT as the first relationship in the table generation simulation SM2b. Therefore, it is possible to suppress the increase in the time required for the table generation simulation SM2b by setting the table generation simulation SM2b to simulation for a case where the motor 61 is driven in the second drive pattern DP2 shorter than the first drive pattern DP1. As described above, in the main simulation SM2c, it is possible to shorten more time than the time required to execute the table generation simulation SM2b. Thus, according to the second embodiment, the time required for the entire simulation of the motor system 260 can be further shortened.

According to the second embodiment, executing the arithmetic operation includes calculating a voltage value at a predetermined location of the second simulation model 270B in the table generation simulation SM2b, calculating the noise table NT as the second relationship between the motor-specific current I and a noise level of electromagnetic interference noise occurring in the second simulation model 270B on the basis of the voltage value calculated in the table generation simulation SM2b, and calculating the noise level in the main simulation SM2c on the basis of the noise table NT serving as the second relationship and the motor-specific current I output in the main simulation SM2c. Therefore, in the main simulation SM2c, the noise level of electromagnetic interference noise can be calculated without reproducing the transient response during switching of the switching element 66.

According to the second embodiment, executing the arithmetic operation includes extracting the second time-series data DC2 of a load from the mechanical model 72 to the motor model 71 in the pre-simulation SM2a and setting the mechanical model 72 in the main simulation SM2c to a model from which the second time-series data DC2 is output to the motor model 71 along a time series. Therefore, in the main simulation SM2c, it is not necessary to perform an arithmetic operation for driving each part of the mechanical model 72. Therefore, the time required for the main simulation SM2c can be shortened compared to the case where the mechanical model 72 in the main simulation SM2c is set to the detailed mechanical model 72D.

According to the second embodiment, executing the arithmetic operation includes setting the mechanical model 72 in the table generation simulation SM2b to the first simplified mechanical model 272Sa from which a load corresponding to a rotation speed of the motor model 71, i.e., the motor rotation speed N, is output to the motor model 71. In the table generation simulation SM2b, it is only necessary to change the motor-specific current I, for example, as in the second drive pattern DP2, so that the heat table HT which is the first relationship is calculated. Therefore, in the table generation simulation SM2b, the mechanical model 72 may be any model as long as the motor-specific current I can be changed. Therefore, by setting the mechanical model 72 to a simplified model from which a load corresponding to the motor rotation speed N is output, it is possible to calculate the heat table HT and shorten the time required for the table generation simulation SM2b.

According to the second embodiment, the time step width in the pre-simulation SM2a is larger than the time step width in the table generation simulation SM2b. Therefore, the time required for the pre-simulation SM2a can be further shortened. Therefore, the time required for the entire simulation of the motor system 260 can be further shortened.

According to the second embodiment, the time step width in the main simulation SM2c is larger than the time step width in the table generation simulation SM2b. Therefore, the time required for the main simulation SM2c can be further shortened. Therefore, the time required for the entire simulation of the motor system 260 can be further shortened.

According to the second embodiment, executing the arithmetic operation includes extracting the third time-series data DC3 of the drive capability control signal AS output from the control model 74 in the pre-simulation SM2a and setting the control model 74 in the main simulation SM2c to the simplified control model 274S from which the first time-series data DC1 and the third time-series data DC3 are output along a time series. Therefore, even if the controller 264 outputs the drive capability control signal AS, the time required for the main simulation SM2c can be shortened by setting the control model 74 to the simplified control model 274S.

According to at least one embodiment described above, the arithmetic method of the embodiment is an arithmetic method of a computer. The arithmetic method of the embodiment includes executing an arithmetic operation including simulation using a simulation model having an element model corresponding to a switching element and a control model corresponding to a controller that controls a control target by driving the switching element. Executing the arithmetic operation includes performing first simulation when the control target is driven in a first drive pattern using the simulation model in which the element model is a model in which electrical characteristics of the switching element are resistance characteristics, extracting first time-series data of a drive signal output from the control model in the first simulation, and performing second simulation when the control target is driven in the first drive pattern using the simulation model in which the control model is a model from which the first time-series data is output along a time series and in which the element model is a model in which power loss including switching loss that occurs when a state of the switching element is switched can be output. Thereby, the time required for simulation can be shortened.

It is only necessary for the element model for use in the second simulation to output power loss including switching loss occurring when the state of the switching element is switched. The element model used in the second simulation may be a model in which power loss can be calculated by reproducing the transient response of the switching element as in the detailed element model 76D of the first embodiment or may be a model in which power loss can be output on the basis of other information such as the heat table HT (the first relationship) in which the transient response of the switching element is not reproduced as in the intermediate element model 276M of the second embodiment. When the power loss in the switching element is calculated by reproducing the transient response of the switching element in the simulation of the embodiment, the specific method for calculating the power loss is not particularly limited as long as the power loss can be calculated. When the noise level of electromagnetic interference noise caused by the switching element is calculated by reproducing the transient response of the switching element in the simulation of the embodiment, the specific method for calculating the noise level is not particularly limited as long as the noise level can be calculated.

The simulation target in the arithmetic method of the embodiment may be any target as long as it has a switching element and a controller that drives the switching element and controls the control target. The control target is not particularly limited. The first drive pattern may be any drive pattern. The second drive pattern may be any drive pattern as long as it is a pattern in which the motor-specific current changes and is a drive pattern in which the time in which the motor is driven is shorter than in the first drive pattern.

At least some functions of the arithmetic circuitry in the arithmetic device described in the above-described embodiment, for example, are implemented by a microprocessor executing a program, i.e., software, recorded on a storage. The program is, for example, a program for causing a computer to execute an arithmetic method described in the above-described embodiment. Also, at least some functions of the arithmetic circuitry in the arithmetic device, for example, may be implemented by hardware including a circuit unit such as a large-scale integration (LSI) circuit, an application-specific integrated circuit (ASIC), a field-programmable gate array (FPGA), or a graphics processing unit (GPU) or may be implemented by software and hardware in cooperation.

The functionality of the elements disclosed herein may be implemented using circuitry or processing circuitry which includes general purpose processors, special purpose processors, integrated circuits, ASICs, FPGAs, conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arithmetic method of a computer, the arithmetic method comprising:
executing an arithmetic operation including simulation using a simulation model having an element model corresponding to a switching element and a control model corresponding to a controller that controls a control target by driving the switching element,
wherein executing the arithmetic operation includes
performing first simulation when the control target is driven in a first drive pattern using the simulation model in which the element model is a model in which electrical characteristics of the switching element are resistance characteristics,
extracting first time-series data of a drive signal output from the control model in the first simulation, and
performing second simulation when the control target is driven in the first drive pattern using the simulation model in which the control model is a model from which the first time-series data is output along a time series and in which the element model is a model in which power loss including switching loss that occurs when a state of the switching element is switched can be output.

2. The arithmetic method according to claim 1,
wherein the control target is a motor to which a motor-specific current is supplied from an inverter circuit having a plurality of switching elements,
wherein the simulation model has
an inverter circuit model corresponding to the inverter circuit and having a plurality of element models, and
a motor model corresponding to the motor,
wherein executing the arithmetic operation includes
performing third simulation when the motor is driven in a second drive pattern in which the motor-specific current changes using the simulation model in which the element model is a model in which electrical characteristics in a transient response when the state of the switching element is switched can be reproduced after the first simulation is executed and before the second simulation is executed,
calculating a first relationship between the motor-specific current and the switching loss on the basis of the switching loss in the element model calculated in the third simulation, and
setting the element model in the second simulation to a model from which the power loss including the switching loss corresponding to the motor-specific current is output on the basis of the first relationship, and
wherein a period of time in which the motor is driven in the second drive pattern is shorter than a period of time in which the motor is driven in the first drive pattern.

3. The arithmetic method according to claim 2, wherein executing the arithmetic operation includes
calculating a voltage value at a predetermined location of the simulation model in the third simulation,
calculating a second relationship between the motor-specific current and a noise level of electromagnetic interference noise occurring in the simulation model on the basis of the voltage value calculated in the third simulation, and
calculating the noise level in the second simulation on the basis of the second relationship and the motor-specific current output in the second simulation.

4. The arithmetic method according to claim 2,
wherein the simulation model has a mechanical model corresponding to a driven device driven by the motor, and
wherein executing the arithmetic operation includes
extracting second time-series data of a load from the mechanical model to the motor model in the first simulation, and
setting the mechanical model in the second simulation to a model from which the second time-series data is output to the motor model along a time series.

5. The arithmetic method according to claim 4, wherein executing the arithmetic operation includes setting the mechanical model in the third simulation to a model from which a load corresponding to a rotation speed of the motor model is output to the motor model.

6. The arithmetic method according to claim 2, wherein a time step width in the first simulation is larger than a time step width in the third simulation.

7. The arithmetic method according to claim 2, wherein a time step width in the second simulation is larger than a time step width in the third simulation.

8. The arithmetic method according to claim 1, wherein a time step width in the first simulation is larger than a time step width in the second simulation.

9. The arithmetic method according to claim 1,
wherein the controller outputs a drive capability control signal for changing characteristics of the switching element to the switching element, and
wherein executing the arithmetic operation includes
extracting third time-series data of the drive capability control signal output from the control model in the first simulation, and
setting the control model in the second simulation to a model from which the first time-series data and the third time-series data are output along a time series.

10. An arithmetic device comprising:
an arithmetic circuitry configured to execute an arithmetic operation including simulation using a simulation model having an element model corresponding to a switching element and a control model corresponding to a controller that controls a control target by driving the switching element,
wherein the arithmetic circuitry is configured to
perform first simulation when the control target is driven in a first drive pattern using the simulation model in which the element model is a model in which electrical characteristics of the switching element are resistance characteristics,
extract first time-series data of a drive signal output from the control model in the first simulation, and
perform second simulation when the control target is driven in the first drive pattern using the simulation model in which the control model is a model from which the first time-series data is output along a time series and in which the element model is a model in which power loss including switching loss that occurs when a state of the switching element is switched can be output.

11. A program for causing a computer to execute an arithmetic method,
wherein the arithmetic method includes executing an arithmetic operation including simulation using a simulation model having an element model corresponding to a switching element and a control model corresponding to a controller that controls a control target by driving the switching element, and
wherein executing the arithmetic operation includes
performing first simulation when the control target is driven in a first drive pattern using the simulation model in which the element model is a model in which electrical characteristics of the switching element are resistance characteristics,
extracting first time-series data of a drive signal output from the control model in the first simulation, and
performing second simulation when the control target is driven in the first drive pattern using the simulation model in which the control model is a model from which the first time-series data is output along a time series and in which the element model is a model in which power loss including switching loss that occurs when a state of the switching element is switched can be output.
